(19) United States
(12) Patent Application Publication
(10) Pub. No.: US 2016/0140449 A1
(43) Pub. Date: May 19, 2016

(54) FUZZY LINEAR PROGRAMMING METHOD FOR OPTIMIZING CHARGING SCHEDULES IN UNIDIRECTIONAL VEHICLE-TO-GRID SYSTEMS

(71) Applicant: KING FAHD UNIVERSITY OF PETROLEUM AND MINERALS, Dhahran (SA)

(72) Inventors: MUHAMMAD ABDUL HAFEEZ ANSARI, KARACHI (PK); ALI TALEB AL-AWAMI, DHAHRAN (SA); MOHAMMAD ALI ABIDO, DHAHRAN (SA)

(21) Appl. No.: 14/543,823

(22) Filed: Nov. 17, 2014

(51) Int. Cl. G06N 7/02; G06N 5/02

(52) U.S. Cl. CPC G06N 7/02; G06N 5/022

(57) ABSTRACT

The fuzzy linear programming method for optimizing charging schedules in unidirectional vehicle-to-grid systems is a computerized fuzzy linear programming method for an electric vehicle (EV) aggregator that coordinates the provision of ancillary services, such as regulation and spinning reserves, to electricity markets using unidirectional vehicle-to-grid (V2G). The fuzzy optimization incorporates uncertainties while maintaining the tractability of the problem size since, in fuzzy optimization, there is no need to represent each stochastic parameter by a number of scenarios. This allows for optimizing the charging of all EVs simultaneously, as well as taking market aspects into account, guaranteeing maximization of aggregator profits, and further considering electricity market uncertainties, such as ancillary service prices and ancillary service deployment signals.

### BACKGROUND OF THE INVENTION

1. Field of the Invention

The present invention relates to vehicle-to-grid (V2G) systems, and particularly to a fuzzy linear programming method for optimizing charging schedules in unidirectional V2G systems, where the method coordinates the provision of ancillary services, such as regulation and spinning reserves, to electricity markets using unidirectional V2G.

2. Description of the Related Art

Vehicle-to-grid (V2G) is a system which allows plug-in electric vehicles (EVs), such as electric cars and plug-in hybrids (PHEVs), to communicate with the power grid to sell demand response services by either delivering electricity into the grid or by throttling their charging rate. When fully implemented, the V2G concept allows electric vehicles to provide power to help balance loads by “valley filling” (i.e., charging at night when demand is low) and “peak shaving” (i.e., sending power back to the grid when demand is high). V2G can enable utilities to provide new types of regulation services (i.e., keeping voltage and frequency stable) and to provide spinning reserves (i.e., meeting sudden demands for power).

Because the V2G system acts by throttling the charging rate of an EV and possibly discharging the energy stored in EVs' batteries, V2G is able to provide a wide variety of benefits to the power grid, particularly in ways that are far more environmentally friendly than internal combustion engine vehicles, and further providing various monetary benefits for EV owners. Through use of V2G, an EV owner can potentially generate revenues by participating in different electricity markets and can, thus, reduce the vehicle's net operational costs.

In order to participate in energy and ancillary services markets, aggregation of the electric vehicles is required because the current market regulations require minimum bid sizes in the megawatt (MW) range, and a single EV does not have that capacity. Additionally, a single EV cannot provide the necessary level of availability and reliability to participate in ancillary services markets without great inconvenience to the owner. Therefore, V2G aggregators are required.

It has been shown that the most profitable service that EVs can provide to the electricity markets is regulation. As suggested by many studies, the proper utilization of EV resources requires the existence of aggregators that serve as intermediaries between the electricity market and the EV owners. The power flow in an EV can be unidirectional or bidirectional. In unidirectional V2G, regulation and responsive reserves support can be provided. Despite the fact that unidirectional V2G has fewer benefits than bidirectional V2G, the former is expected to be widely implemented before the full implementation of the latter. Thus, a considerable amount of work in unidirectional V2G has already been performed. Several optimized charging algorithms have been proposed. However, thus far, most have been deterministic, i.e., no uncertainties are considered for day-ahead aggregated bidding. In reality, an aggregator must consider the uncertainties of the electricity markets, such as those associated with regulation prices, energy prices and deployment signals. Otherwise, trading the regulation service in these markets typically would be extremely risky.

In order to handle uncertainties related to power system operations, different optimization approaches have been suggested. For example, stochastic programming has been used for formulating a security constrained unit commitment for a system that has significant penetration of EVs. However, no market aspects were taken into account. Sequential linear programming was also used to minimize the deviations between the scheduled and actual levels of EV charging. However, in such a scheme, aggregator profits are not guaranteed to be maximized. A further stochastic approach was attempted for an EV aggregator offering regulation services to the electricity market. However, a pre-determined contract was assumed to have been already signed between the aggregator and the market operator. The contract terms determine the regulation capacity to be provided by the aggregator at a pre-defined price. Therefore, regulation capacity and price are assumed to be deterministic. Additionally, Monte Carlo simulations have been used to account for the uncertainties corresponding to the EV driving patterns, energy market prices, and regulation energy requirements, although in order to reduce the problem size to a tractable range, the EVs with similar driving behavior were grouped into fleets. Then, charging of each fleet was optimized separately. This reduced the size of the problem by dividing it into multiple smaller optimization sub-problems that could be solved in parallel. Such an approach may result in a sub-optimal solution.

Since fuzzy optimization has been used successfully to handle the uncertainties in regulated power system problems, such as unit commitment and economic dispatch, it would be desirable to be able to apply fuzzy set theory to the problem of optimizing the charging of EVs and the bidding of ancillary services in the electricity market. Fuzzy set theory would allow for consideration of the different market uncertainties, such as those in the forecast data of the electricity market, including regulation up/down prices and regulation deployment signals. Fuzzy linear programming is an extension of linear programming (LP) that allows for incorporating uncertainties in model parameters. In pursuit of a fuzzy formulation, some of the elements in the LP are reformulated as fuzzy objectives and fuzzy constraints.

The fuzzy set theory is a mathematical technique that allows the modeling of imprecise or conflicting engineering problems. Fuzzy optimization transforms the objectives and constraints into satisfaction functions of fuzzy sets. Optimality is achieved by maximizing the intersection of these satisfaction functions of the problem. Considering a problem including of a number of objectives, I, and number of constraints, J, each objective I is associated with a fuzzy set Zᵢ={(uᵢ, μ_{Z}_{ᵢ}(uᵢ)εUᵢ)}, where the subscript i refers to the i-th objective function, uᵢ is the value the i-th objective function assumes, Uᵢ is i-th objective space, and μ_{Z}_{ᵢ}(uᵢ) is the membership function that defines the satisfaction parameter of the degree of closeness of the i-th objective to the optimal value. Similarly, each constraint is associated with a fuzzy set Cⱼ={(uⱼ, μ_{C}_{ⱼ}(uⱼ)εUⱼ)}, where the subscript j refers to the j-th constraint, uⱼ is the value the j-th constraint assumes, Uⱼ is j-th constraint space, and μ_{C}_{ⱼ}(uⱼ) is the membership function that defines the satisfaction parameter of the degree of closeness of the j-th constraint to the optimum.

Mathematically, the fuzzy optimization procedure can be stated as:

Maximize λ, (1)

where

λ=min{μ_{Z}_{₁},μ_{Z}_{₂},μ_{Z}_{₃}, . . . ,μ_{Z}_{_{I}},μ_{C}_{₁},μ_{C}_{₂},μ_{C}_{₃}, . . . ,μ_{C}_{_{J}}}, (2)

where the min function determines the minimum of the satisfaction values. All of the membership functions are defined in the range of [0, 1]. During the optimization, λ assumes a value that equals the least of all of the satisfaction parameters. As λ is maximized, individual fuzzy satisfaction parameters relating to the objectives and constraints are consequently optimized.

Returning to V2G, in unidirectional V2G, the EVs cannot discharge into the grid. Thus, the ancillary service capacities that the aggregator can provide are based on the extent of moving the actual charging rate of each of the EVs above or below its scheduled charging rate, which is also called the preferred operating point (POP). The potential charge rates are between the maximum charge rate and zero. The aggregator must optimize the values of the POPs and the ancillary service capacities to be provided to the electricity market in a way that maximizes its profits. According to the regulations of the market under consideration, it is assumed that the aggregator submits its bids a day ahead. Therefore, it is exposed to several market uncertainties that need to be accounted for while devising the day-ahead bids, and the aggregator must schedule the POP in an intelligent manner in order to maximize its profits.

It is assumed that the communication infrastructure already exists between the aggregator and each EV. In a charging method for V2G, in real time, the aggregator initially adjusts the actual charging rate of each EV to be equal to POPᵢ. If a regulation or responsive reserve signal is received from the system operator, the aggregator will modify the charging rate of each EV accordingly. It would obviously be desirable to be able to mathematically optimize the aggregator's day-ahead bids in order to maximize its profits, particularly taking into account the modeling of the uncertainties of the electricity market parameters, such as price and regulation deployments.

Thus, a fuzzy linear programming method for optimizing charging schedules in unidirectional vehicle-to-grid systems addressing the aforementioned problems is desired.

### SUMMARY OF THE INVENTION

The fuzzy linear programming method for optimizing charging schedules in unidirectional vehicle-to-grid systems is a computerized fuzzy linear programming method for an electric vehicle (EV) aggregator that coordinates the provision of ancillary services, such as regulation and spinning reserves, to electricity markets using unidirectional vehicle-to-grid (V2G). The fuzzy optimization incorporates uncertainties while maintaining the tractability of the problem size, since in fuzzy optimization there is no need to represent each stochastic parameter by a number of scenarios. This allows for optimizing the charging of all EVs simultaneously, as well as taking market aspects into account, guaranteeing maximization of aggregator profits, and further considering electricity market uncertainties, such as ancillary service prices and ancillary service deployment signals.

The fuzzy linear programming method for optimizing charging schedules in unidirectional vehicle-to-grid systems maximizes a fuzzy objective function λ, where

$$λ = min \{ {μ}_{In} , {μ}_{regUp} , {μ}_{regDw} , {μ}_{RR} , {μ}_{{E}_{{x}_{U}}} , {μ}_{{E}_{{x}_{D}}} , {μ}_{{E}_{{x}_{R}}} \} ,$$

to determine the scheduled charging rates (POPs) and the ancillary service capacities to be provided to the electricity markets at each dispatch period for each of N electric vehicles, where the fuzzy objective function λ is maximized subject to the following conditions:

(I̅n̅−In)λ+In≦In,

(P̅_̅{̅r̅e̅g̅U̅p̅}̅−P_{regUp})λ+P_{regUp}≦P_{regUp},

(P̅_̅{̅r̅e̅g̅D̅w̅}̅−P_{regDw})λ+P_{regDw}≦P_{regDw},

(P̅_̅{̅R̅R̅}̅−P_{RR})λ+P_{RR}≦P_{RR},

(E̅ₓ̅_̅{̅_̅{̅U̅}̅}̅−Eₓ_{_{U}})λ+Eₓ_{_{U}}≦E̅ₓ̅_̅{̅_̅{̅U̅}̅}̅,

(E̅ₓ̅_̅{̅_̅{̅D̅}̅}̅−Eₓ_{_{D}})λ+Eₓ_{_{D}}≦E̅ₓ̅_̅{̅_̅{̅D̅}̅}̅, and

(E̅ₓ̅_̅{̅_̅{̅R̅}̅}̅−Eₓ_{_{R}})λ+Eₓ_{_{R}}≦E̅ₓ̅_̅{̅_̅{̅R̅}̅}̅,

where In is a fuzzy objective function representing an aggregator income, such that In=[Σₜ(P_{regUp}·R_{Up}+P_{regDw}·R_{Down}+P_{RR}·R_{RR})+βΣᵢΣᵢ(E(FPᵢ))]·EVₚₑᵣ(t), where β is a fixed energy price rate for an EV owner, P_{regUp} is a market price of regulation up, P_{regDw} is a market price of regulation down, R_{Up} is a regulation up capacity, R_{down} is a regulation down capacity, P_{RR} is a market price of response reserves, R_{RR} is a response reserve capacity, E( ) represents an expectation value, FPᵢ is a final power draw of the i-th EV, EVₚₑᵣ(t) is an expected percentage of EVs remaining to perform V2G charging at hour t, I̅n̅ is an upper limit of the aggregator income, In is a lower limit of the aggregator income, P̅_̅{̅r̅e̅g̅U̅p̅}̅ is an upper limit of the market price of regulation up, P_{regUp} is a lower limit of the market price of regulation up, P̅_̅{̅r̅e̅g̅D̅w̅}̅ is an upper limit of the market price of regulation down, P_{regDw} is a lower limit of the market price of regulation down, P̅_̅{̅R̅R̅}̅ is an upper limit of the market price of response reserves, P_{RR} is a lower limit of the market price of response reserves, Eₓ_{_{U}} is an expected percentage of regulation up deployments, E̅ₓ̅_̅{̅_̅{̅U̅}̅}̅ is an upper limit of the expected percentage of regulation up deployments, Eₓ_{_{U}} is a lower limit of the expected percentage of regulation up deployments, Eₓ_{_{D}} is an expected percentage of regulation down deployments, E̅ₓ̅_̅{̅_̅{̅D̅}̅}̅ is an upper limit of the expected percentage of regulation down deployments, Eₓ_{_{D}} is a lower limit of the expected percentage of regulation down deployments, Eₓ_{_{R}} is an expected percentage of response reserve deployment, E̅ₓ̅_̅{̅_̅{̅R̅}̅}̅ is an upper limit of the expected percentage of response reserve deployment, Eₓ_{_{R}} is a lower limit of the expected percentage of response reserve deployment, and

$${μ}_{In} , {μ}_{regUp} , {μ}_{regDw} , {μ}_{RR} , {μ}_{{E}_{{x}_{U}}} , {μ}_{{E}_{{x}_{D}}} , {μ}_{{E}_{{x}_{R}}}$$

are, respectively, membership functions for aggregator income, market price of regulation up, market price of regulation down, price of response reserve, expected percentage of regulation up deployments, expected percentage of regulation down deployments, and expected percentage of response reserve deployment, where

$${μ}_{I n} = \{ \begin{matrix}0 & for In \leq \underline{In} \\ \frac{In - \underline{In}}{\overline{In} - \underline{In}} & for \underline{In} \leq In \leq \overline{In} \\ 1 & for In \geq \overline{In}\end{matrix} , \\ {μ}_{regUp} = \{ \begin{matrix}0 & for {P}_{regUp} \leq \underline{{P}_{regUp}} \\ \frac{{P}_{regUp} - \underline{{P}_{regUp}}}{\overline{{P}_{regUp}} - \underline{{P}_{regUp}}} & for \underline{{P}_{regUp}} \leq {P}_{regUp} \leq \overline{{P}_{regUp}} \\ 1 & for {P}_{regUp} \geq \overline{{P}_{regUp}}\end{matrix} , \\ {μ}_{regDw} = \{ \begin{matrix}0 & for {P}_{regDw} \leq \underline{{P}_{regDw}} \\ \frac{{P}_{regDw} - \underline{{P}_{regDw}}}{\overline{{P}_{regDw}} - \underline{{P}_{regDw}}} & for \underline{{P}_{regDw}} \leq {P}_{regDw} \leq \overline{{P}_{regDw}} \\ 1 & for {P}_{regDw} \geq \overline{{P}_{regDw}}\end{matrix} , \\ {μ}_{RR} = \{ \begin{matrix}0 & for {P}_{RR} \leq \underline{{P}_{RR}} \\ \frac{{P}_{RR} - \underline{{P}_{RR}}}{\overline{{P}_{RR}} - \underline{{P}_{RR}}} & for \underline{{P}_{RR}} \leq {P}_{RR} \leq \overline{{P}_{RR}} \\ 1 & for {P}_{RR} \geq \overline{{P}_{RR}}\end{matrix} , \\ {μ}_{{E}_{{x}_{U}}} = \{ \begin{matrix}1 & for {E}_{{x}_{U}} \leq \underline{{E}_{{x}_{U}}} \\ \frac{\overline{{E}_{{x}_{U}}} - {E}_{{x}_{U}}}{\overline{{E}_{{x}_{U}}} - \underline{{E}_{{x}_{U}}}} & for \underline{{E}_{{x}_{U}}} \leq {E}_{{x}_{U}} \leq \overline{{E}_{{x}_{U}}} \\ 0 & for {E}_{{x}_{U}} \geq \overline{{E}_{{x}_{U}}}\end{matrix} , \\ {μ}_{{E}_{{x}_{D}}} = \{ \begin{matrix}1 & for {E}_{{x}_{D}} \leq \underline{{E}_{{x}_{D}}} \\ \frac{\overline{{E}_{{x}_{D}}} - {E}_{{x}_{D}}}{\overline{{E}_{{x}_{D}}} - \underline{{E}_{{x}_{D}}}} & for \underline{{E}_{{x}_{D}}} \leq {E}_{{x}_{D}} \leq \overline{{E}_{{x}_{D}}} \\ 0 & for {E}_{{x}_{D}} \geq \overline{{E}_{{x}_{D}}}\end{matrix} , \\ {μ}_{{E}_{{x}_{R}}} = \{ \begin{matrix}1 & for {E}_{{x}_{R}} \leq \underline{{E}_{{x}_{R}}} \\ \frac{\overline{{E}_{{x}_{R}}} - {E}_{{x}_{R}}}{\overline{{E}_{{x}_{R}}} - \underline{{E}_{{x}_{R}}}} & for \underline{{E}_{{x}_{R}}} \leq {E}_{{x}_{R}} \leq \overline{{E}_{{x}_{R}}} \\ 0 & for {E}_{{x}_{R}} \geq \overline{{E}_{{x}_{R}}}\end{matrix} ,$$

and further subject to a cost function C=Σᵢ Σₜ(E(FPᵢ)·P(t)·EVₚₑᵣ(t), where P(t) is an energy market price at time t, and further subject to the following constraints:

Σᵢ^{T}^{_{trip,i}}E(FPᵢ(t))·Compᵢ(t)·Efᵢ(t)+SOC_{I,i}≦M_{Ci},

ΣᵢE(FPᵢ(t))·Compᵢ(t)·Efᵢ(t)+SOC_{I,i}−Tripᵢ≦M_{Ci},

(MxAPᵢ(t)+POPᵢ(t))·Compᵢ(t)·Efᵢ(t)+SOC_{I,i}≦M_{Ci},

RsRPᵢ(t)≦POPᵢ(t)−MnAPᵢ(t),

(MxAPᵢ(t)+POPᵢ(t))−Compᵢ(t)≦MPᵢ·Avᵢ(t),

SOCfᵢ≧SOCfdᵢ,

MxAPᵢ(t)≧0,

MnAPᵢ(t)≧0,

RsRPᵢ(t)≧0, and

POPᵢ(t)≧0,

where the expected value of the energy received by the i-th EV is given by E(FPᵢ(t))≦MxAPᵢ(t)Eₓ_{_{D}}+POPᵢ(t)−MnAPᵢ(t)Eₓ_{_{U}}−RsRPᵢ(t)Eₓ_{_{R}}, T_{trip,i} is a time at which the i-th EV makes a commute trip, Compᵢ(t) is a compensation factor to account for unplanned departures of the i-th EV, Efᵢ is the efficiency of a battery charger connected to a battery of the i-th EV, SOC_{I,i} is the initial state of charge of the battery of the i-th EV, M_{Ci} is the maximum charge of the battery of the i-th EV, Tripᵢ is a reduction in the state of charge (SOC) of the battery of the i-th EV as a result of the commute trip, MxAPᵢ(t) is a maximum additional power draw of the i-th EV at time t, POPᵢ(t) is a preferred operating point of the i-th EV at time t, RsRPᵢ(t) is a reduction in power draw of the i-th EV available for spinning reserves, MnAPᵢ(t) is a minimum additional power draw of the i-th EV at time t, MPᵢ is a power rating of the battery charger connected to the battery of the i-th EV, Avᵢ(t) is an availability of the i-th EV for V2G charging, where Avᵢ(t)=1 if the i-th EV is available for V2G charging and Avᵢ(t)=0 if the i-th EV is not available for V2G charging, SOCfᵢ is a final state of charge of the battery of the i-th EV, and SOCfdᵢ is a desired final state of charge of the battery of the i-th EV, and

$${Comp}_{i} ( t ) = 1 + \frac{{Dep}_{i} ( t )}{1 - {Dep}_{i} ( t )}$$

$$and$$

$${EV}_{per} ( t ) = \{ \begin{matrix}1 - {\sum }_{time = 1}^{t} {Σ}_{i} {Dep}_{i} ( time ) & if t < {T}_{trip , i} \\ 1 - {\sum }_{time = {T}_{trip}}^{t} {Σ}_{i} {Dep}_{i} ( time ) & if t \geq {T}_{trip , i}\end{matrix} ,$$

where Depᵢ(t) is a probability that the i-th EV will depart unexpectedly at hour t, and R_{Up}(t)=Σᵢ₌₁^{N}MnAPᵢ(t), R_{Down}(t)=Σᵢ₌₁^{N}MxAPᵢ(t) and R_{RR}(t)=Σᵢ₌₁^{N}RsRPᵢ(t), where N is the total number of EVs.

Note that the fuzzy optimization is carried out one day ahead of the implementation day by maximizing the objective function λ to determine the scheduled charging rates (POPᵢ) and the ancillary service capacities (MnAPᵢ, MxAPᵢ, and RsRPᵢ) to be provided to the electricity markets at each dispatch period t for each of N electric vehicles. Once the optimization results are obtained, the aggregator sends these results (i.e., POPᵢ, MnAPᵢ, MxAPᵢ, and RsRPᵢ for all dispatch periods) to the ancillary service markets. If the bids are accepted by the market operator (they are usually guaranteed to be accepted, since the aggregator bids these capacities at zero price), the aggregator is required to respond to the system operator's regulation and reserve signals (if any) during real-time operation. During real-time operation, a regulation or a responsive reserve signal might be sent by the operator to the aggregator. According to these signals, the aggregator adjusts the scheduled charging rate of each EV proportionally. The adjusted charging signal is transmitted to the i-th battery charger in communication with the battery of the i-th EV.

These and other features of the present invention will become readily apparent upon further review of the following specification.

### BRIEF DESCRIPTION OF THE DRAWINGS

FIG. 1 is a graph illustrating a fuzzy model of total aggregator income used in a fuzzy linear programming method for optimizing charging schedules in unidirectional vehicle-to-grid systems according to the present invention.

FIG. 2 is a graph illustrating a fuzzy model of expected regulation up deployments used in the fuzzy linear programming method for optimizing charging schedules in unidirectional vehicle-to-grid systems according to the present invention.

FIG. 3 is graph showing average percentage of electric vehicle (EV) availability over a 24 hour period for a simulation of the fuzzy linear programming method for optimizing charging schedules in unidirectional vehicle-to-grid systems according to the present invention.

FIG. 4 is graph showing average ancillary service prices for the simulation period using historical data for the simulation of the fuzzy linear programming method for optimizing charging schedules in unidirectional vehicle-to-grid systems, specifically showing regulation up prices, regulation down prices and responsive reserve prices.

FIG. 5 is a graph comparing average preferred operating point of a conventional deterministic charging algorithm against the fuzzy linear programming method for optimizing charging schedules in unidirectional vehicle-to-grid systems according to the present invention.

FIG. 6 is graph comparing average regulation ups of the conventional deterministic charging algorithm against the fuzzy linear programming method for optimizing charging schedules in unidirectional vehicle-to-grid systems according to the present invention.

FIG. 7 is graph comparing average regulation downs of the conventional deterministic charging algorithm against the fuzzy linear programming method for optimizing charging schedules in unidirectional vehicle-to-grid systems according to the present invention.

FIG. 8 is graph comparing average response reserves of the conventional deterministic charging algorithm against the fuzzy linear programming method for optimizing charging schedules in unidirectional vehicle-to-grid systems according to the present invention.

FIG. 9 is graph comparing available, or remaining, battery capacities of the conventional deterministic charging algorithm against the fuzzy linear programming method for optimizing charging schedules in unidirectional vehicle-to-grid systems according to the present invention.

FIG. 10 is graph comparing total expected profits against actual profits of an aggregator for both the conventional deterministic charging algorithm and the fuzzy linear programming method for several values of EV owners' energy charge rate for optimizing charging schedules in unidirectional vehicle-to-grid systems according to the present invention.

FIG. 11 is a graph showing final state of charge (SOC) statistics for the simulation of the fuzzy linear programming method for optimizing charging schedules in unidirectional vehicle-to-grid systems.

FIG. 12 is a graph comparing final SOCs of the conventional deterministic charging algorithm against the fuzzy linear programming method for optimizing charging schedules in unidirectional vehicle-to-grid systems according to the present invention.

FIG. 13 is a graph comparing total actual profits for different levels of final desired SOC of the conventional deterministic charging algorithm against the fuzzy linear programming method for optimizing charging schedules in unidirectional vehicle-to-grid systems according to the present invention.

FIG. 14A is a schematic diagram illustrating the bidding-acknowledgement interface between an aggregator and an independent service operator (ISO) in a fuzzy linear programming method for optimizing charging schedules in unidirectional vehicle-to-grid systems according to the present invention.

FIG. 14B is a block diagram illustrating system components for implementing regulation and reserve provision in real-time operation using the optimized charging schedules obtained from the fuzzy linear programming method and regulation and reserve signals sent by the system operator to the aggregator in unidirectional vehicle-to-grid systems according to the present invention.

Similar reference characters denote corresponding features consistently throughout the attached drawings.

### DETAILED DESCRIPTION OF THE PREFERRED EMBODIMENTS

In the present fuzzy linear programming method for optimizing charging schedules in unidirectional vehicle-to-grid systems, a main objective of the optimization is to generate maximum profits from the regulation and reserve services by scheduling electric vehicle (EV) charging. Specifically, a main objective of the aggregator is to generate maximum profits from vehicle-to-grid (V2G) by participating in the ancillary services markets. The objective function used is structured so as to charge a fixed energy price to the customers whenever they charge their EVs. The aggregator revenues come from two sources: first, the aggregator gets all of the revenues from the ancillary services markets, and second, it makes profits from the price differences between the fixed energy charges and the market energy price. Since the EVs cannot sell energy to the market in unidirectional V2G, this is only a positive revenue source if the market price is less than the fixed price paid by the EV owners. If market price is higher than the fixed price, however, this will be negative revenue or cost. Such an objective function is practical, since the EV owner will not be exposed to the market price variations. The fixed energy price rate for the EV owner, β, is lower than the average kW-hour domestic energy price (from the independent system operator (ISO) or utility). This works as an incentive in order to attract the EV owners to allow the aggregator to control their charging. If the fixed energy price were not lower than what the EV owners would pay normally, then there would be no reason for them to participate in the V2G system.

The fuzzy objective function is defined as:

In=[Σₜ(P_{regUp}·R_{Up}+P_{regDw}·R_{Down}+P_{RR}·R_{RR})+βΣᵢΣₜ(E(FPᵢ))]·EVₚₑᵣ(t), (3)

where β is the fixed energy price rate for the EV owner, P_{regUp} is a market price of regulation up, P_{regDw} is a market price of regulation down, R_{Up} is a regulation up capacity, R_{Down} is a regulation down capacity, P_{RR} is a market price of response reserves, R_{RR} is a response reserve capacity, E( ) represents an expectation value, FPᵢ is a final power draw of an i-th EV, and EVₚₑᵣ(t) is an expected percentage of EVs remaining to perform V2G at hour t. In the objective function of equation (3), the aggregator charges a fixed price to the customer and purchases the power at the market price for the energy, thus assuming the risk associated with real time pricing. The cost function for this condition that is subtracted from the In is given by:

C=ΣᵢΣₜ(E(FPᵢ))·P(t)·EVₚₑᵣ(t), (4)

where P(t) is the energy market price. The fuzzy set for the aggregator income is defined as:

[symbol]

={[In,μ_{In}],In≦In≦I̅n̅}, (5)

where In is an aggregator income, μ_{In} is a membership function of the aggregator income, In is a lower limit of the aggregator income, and I̅n̅ is an upper limit of the aggregator income.

The fuzzy set is built using the aggregator income In that defines the objective function of equation (3). The possible values of In can be defined through the constraint within the definition of the fuzzy set of equation (5). There is a minimum value of In below which the aggregator will not be willing to participate and the membership function is zero at that income, and an upper value of In above which all of the income is acceptable. These lower and upper limits of the aggregator profits must be decided upon by the aggregator before the fuzzy optimization is carried out. This can be selected to be a certain percentage of the aggregator's profits in the deterministic case; i.e., when the uncertain parameters are represented by their forecasted values only. The membership function μ_{In} in equation (5) is defined as:

$${μ}_{In} = \{ \begin{matrix}0 & for In \leq \underline{In} \\ \frac{In - \underline{In}}{\overline{In} - \underline{In}} & for \underline{In} \leq In \leq \overline{In} \\ 1 & for In \geq \overline{In}\end{matrix} \qquad ( 6 )$$

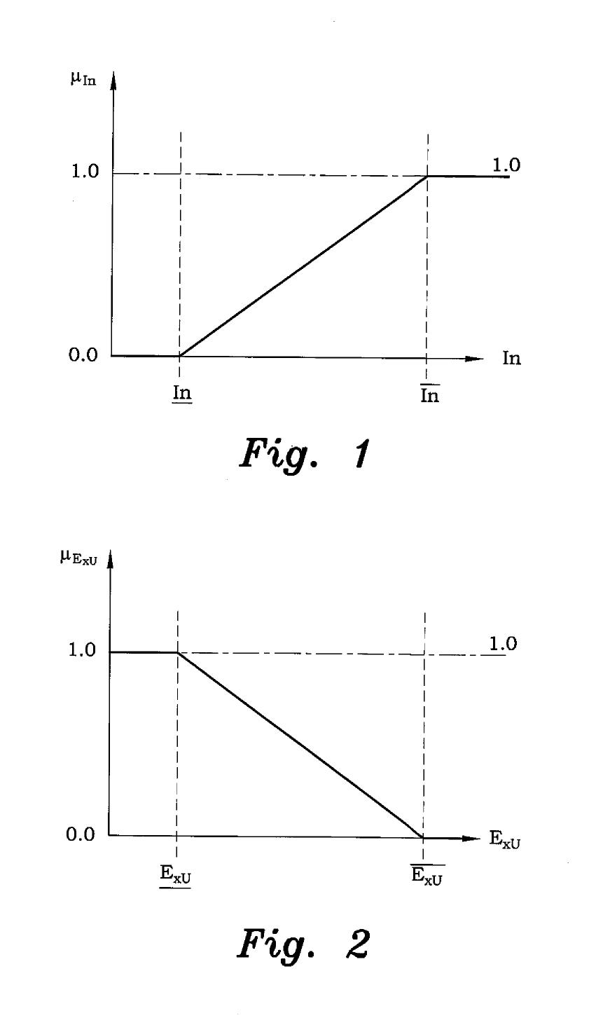

which is shown graphically in FIG. 1.

The fuzzy uncertainty model of the regulation up prices can be represented as:

[symbol]

={[P_{regUp},μ_{regUp}],P_{regUp}≦P_{regUp}≦P̅_̅{̅r̅e̅g̅U̅p̅}̅}, (7)

where [symbol] is the fuzzy set for the regulation up price, μ_{regUp} is a membership function of a regulation up price, P_{regUp} is a lower limit of the price of regulation up, and P̅_̅{̅r̅e̅g̅U̅p̅}̅ is an upper limit of the price of regulation up. This fuzzy uncertainty model for the ancillary service prices of the day of implementation is developed assuming that there is a certain error in their forecast values. As an aggregator, there is a certain price below which the aggregator will not be willing to participate, as the aggregator will be running at a loss. The minimum regulation prices should be such that the aggregator is making profits after covering all of its expenses. Here, the minimum and the maximum regulation prices are estimated using the forecast prices for the next day (i.e., the day of implementation) using the autoregressive integrated moving average (ARIMA) model. The actual, or realized, values of each of the prices on the day of implementation might deviate from the corresponding forecast. The error (i.e., the difference between the actual and forecasted values) indicates how uncertain each price is. In the optimization, it is the historical values of the mean absolute percentage errors (MAPE) that are used as upper and lower limits for each uncertain price; i.e., if the R_{Up} price is forecast to be \hat{P} and the corresponding MAPE is e, then P_{regUp}=(1−e)\hat{P} and P̅_̅{̅r̅e̅g̅U̅p̅}̅=(1+e)\hat{P}. The membership function for the price of regulation up is given as:

$${μ}_{regUp} = \{ \begin{matrix}0 & for {P}_{regUp} \leq \underline{{P}_{regUp}} \\ \frac{{P}_{regUp} - \underline{{P}_{regUp}}}{\overline{{P}_{regUp}} - \underline{{P}_{regUp}}} & for \underline{{P}_{regUp}} \leq {P}_{regUp} \leq \overline{{P}_{regUp}} \\ 1 & for {P}_{regUp} \geq \overline{{P}_{regUp}}\end{matrix} \qquad ( 8 )$$

and the graphical representation is similar to that of FIG. 1. A similar fuzzy modeling is made for the regulation down prices P_{regDw} and its membership function μ_{regDw}, such that:

$$\begin{matrix}= \{ [ {P}_{regDw} , {μ}_{regDw} ] , \underline{{P}_{regDw}} \leq {P}_{regDw} \leq \overline{{P}_{regDw}} \} , \\ and & ( 9 ) \\ {μ}_{regDw} = \{ \begin{matrix}0 & for {P}_{regDw} \leq \underline{{P}_{regDw}} \\ \frac{{P}_{regDw} - \underline{{P}_{regDw}}}{\overline{{P}_{regDw}} - \underline{{P}_{regDw}}} & for \underline{{P}_{regDw}} \leq {P}_{regDw} \leq \overline{{P}_{regDw}} \\ 1 & for {P}_{regDw} \geq \overline{{P}_{regDw}}\end{matrix} . & ( 10 )\end{matrix}$$

Similarly, the fuzzy model for the responsive reserve price is given by:

$$\begin{matrix}= \{ [ {P}_{RR} , {μ}_{RR} ] , \underline{{P}_{RR}} \leq {P}_{RR} \leq \overline{{P}_{RR}} \} , \\ and & ( 11 ) \\ {μ}_{RR} = \{ \begin{matrix}0 & for {P}_{RR} \leq \underline{{P}_{RR}} \\ \frac{{P}_{RR} - \underline{{P}_{RR}}}{\overline{{P}_{RR}} - \underline{{P}_{RR}}} & for \underline{{P}_{RR}} \leq {P}_{RR} \leq \overline{{P}_{RR}} \\ 1 & for {P}_{RR} \geq \overline{{P}_{RR}}\end{matrix} , & ( 12 )\end{matrix}$$

where [symbol] is the fuzzy set for the regulation down price, μ_{regDw} is the membership function for the regulation down price, [symbol] is the fuzzy set for the responsive reserve price, μ_{RR} is the membership function for the responsive reserve price, P_{regDw} is the lower limit for the regulation down price, P̅_̅{̅r̅e̅g̅D̅w̅}̅ is the upper limit for the regulation down price, P_{RR} is the lower limit for the responsive reserve price, and P̅_̅{̅R̅R̅}̅ is the upper limit for the responsive reserve price.

The expected values of regulation deployments are calculated using the historical deployment signals from the Electric Reliability Council of Texas independent system operator (ERGOT ISO). The hourly actual averages are calculated and the deviations from the forecast values (obtained using ARIMA) are calculated so that the membership functions of the expected percentage of regulation up deployments, Eₓ_{_{U}}, and the expected percentage of regulation down deployments, Eₓ_{_{D}}, can be defined. The fuzzy model for Eₓ_{_{U}} is given as:

$$= \{ [ {E}_{{x}_{U}} , {μ}_{{E}_{{x}_{U}}} ] , \underline{{E}_{{x}_{U}}} \leq {E}_{{x}_{U}} \leq \overline{{E}_{{x}_{U}}} \} , \qquad ( 13 )$$

where [symbol] is the fuzzy set for the expected percentage of regulation up deployments, Eₓ_{_{U}} is the lower limit of the expected percentage of regulation up deployments, E̅ₓ̅_̅{̅_̅{̅U̅}̅}̅ is the upper limit of the expected percentage of regulation up deployments, and

$${μ}_{{E}_{{x}_{U}}}$$

is the membership function for the expected percentage of regulation up deployments, given as:

$${μ}_{{E}_{{x}_{U}}} = \{ \begin{matrix}1 & for {E}_{{x}_{U}} \leq \underline{{E}_{{x}_{U}}} \\ \frac{\overline{{E}_{{x}_{U}}} - {E}_{{x}_{U}}}{\overline{{E}_{{x}_{U}}} - \underline{{E}_{{x}_{U}}}} & for \underline{{E}_{{x}_{U}}} \leq {E}_{{x}_{U}} \leq \overline{{E}_{{x}_{U}}} \\ 0 & for {E}_{{x}_{U}} \geq \overline{{E}_{{x}_{U}}}\end{matrix} . \qquad ( 14 )$$

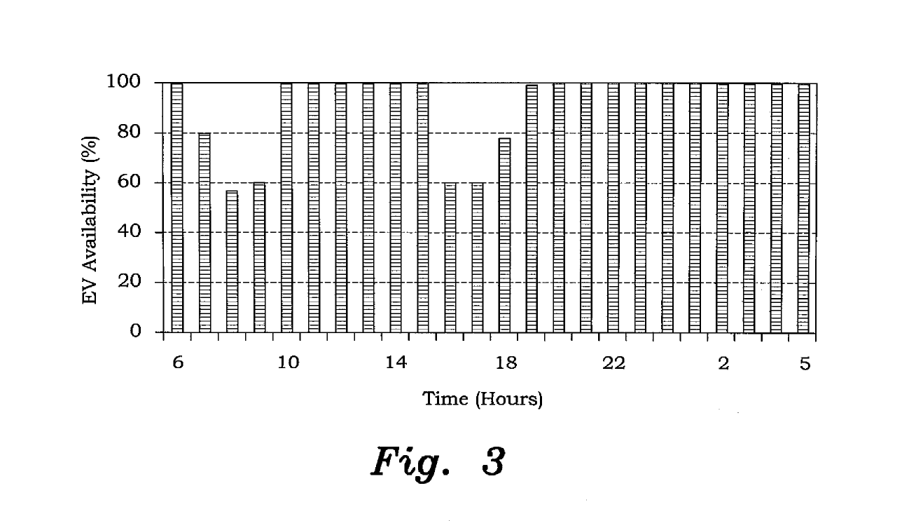

The graphical representation of the Eₓ_{_{U}} membership function is shown in FIG. 2. The expected regulation deployments are defined in an opposite manner to that of regulation prices. If the expected deployments are kept low, the EVs will be available in the market for providing the regulation service for the whole charging period. If they are charged during the early hours, their capacities to provide regulation and responsive reserve in the later hours will be diminished. Similar fuzzy modeling is performed for the expected regulation down deployment Eₓ_{_{D}} and its membership function

$${μ}_{{E}_{{x}_{D}}} ,$$

such that:

$$\begin{matrix}= \{ [ {E}_{{x}_{D}} , {μ}_{{E}_{{x}_{D}}} ] , \underline{{E}_{{x}_{D}}} \leq {E}_{{x}_{D}} \leq \overline{{E}_{{x}_{D}}} \} , \\ and & ( 15 ) \\ {μ}_{{E}_{{x}_{D}}} = \{ \begin{matrix}1 & for {E}_{{x}_{D}} \leq \underline{{E}_{{x}_{D}}} \\ \frac{\overline{{E}_{{x}_{D}}} - {E}_{{x}_{D}}}{\overline{{E}_{{x}_{D}}} - \underline{{E}_{{x}_{D}}}} & for \underline{{E}_{{x}_{D}}} \leq {E}_{{x}_{D}} \leq \overline{{E}_{{x}_{D}}} \\ 0 & for {E}_{{x}_{D}} \geq \overline{{E}_{{x}_{D}}}\end{matrix} , & ( 16 )\end{matrix}$$

where [symbol] is the fuzzy set for the expected percentage of regulation down deployments, Eₓ_{_{D}} is the lower limit of the expected percentage of regulation down deployments, E̅ₓ̅_̅{̅_̅{̅D̅}̅}̅ is the upper limit of the expected percentage of regulation down deployments, and

$${μ}_{{E}_{{x}_{D}}}$$

is the membership function for the expected percentage of regulation down deployments. Similarly, fuzzy modeling is performed for the expected responsive deployment Eₓ_{_{R}} and its membership function

$${μ}_{{E}_{{x}_{R}}} ,$$

such that:

$$\begin{matrix}= \{ [ {E}_{{x}_{R}} , {μ}_{{E}_{{x}_{R}}} ] , \underline{{E}_{{x}_{R}}} \leq {E}_{{x}_{R}} \leq \overline{{E}_{{x}_{R}}} \} , \\ and & ( 17 ) \\ {μ}_{{E}_{{x}_{R}}} = \{ \begin{matrix}1 & for {E}_{{x}_{R}} \leq \underline{{E}_{{x}_{R}}} \\ \frac{\overline{{E}_{{x}_{R}}} - {E}_{{x}_{R}}}{\overline{{E}_{{x}_{R}}} - \underline{{E}_{{x}_{R}}}} & for \underline{{E}_{{x}_{R}}} \leq {E}_{{x}_{R}} \leq \overline{{E}_{{x}_{R}}} \\ 0 & for {E}_{{x}_{R}} \geq \overline{{E}_{{x}_{R}}}\end{matrix} , & ( 18 )\end{matrix}$$

where [symbol] is the fuzzy set for the expected percentage of responsive reserve deployment, Eₓ_{_{R}} is the lower limit of the expected percentage of responsive reserve deployment, E̅ₓ̅_̅{̅_̅{̅R̅}̅}̅ is the upper limit of the expected percentage of responsive reserve deployment, and

$${μ}_{{E}_{{x}_{R}}}$$

is the membership function for the expected percentage of responsive reserve deployment.

As a market participant, the aggregator will strive for the maximum benefits from its V2G assets. The aggregator profits come from two sources: ancillary service bidding and the charging of EVs. The aggregator will get all the revenues from the ancillary service bidding and the difference between the energy market price and the fixed energy charges that the aggregator collects from the EV owners. The uncertainties are considered in a fuzzy set by calculating the forecasting errors in the actual and the historical data of ERCOT ISO for the regulation up/down prices and the regulation deployments. The membership functions of the income, ancillary services prices and the expected deployments have to be translated into a fuzzy objective and fuzzy constraints. The final transformed equations are given below in equations (19)-(25), and equation (26) defines the fuzzy objective in a manner similar to that presented in equation (2):

(I̅n̅−In)λ+In≦In (19)

(P̅_̅{̅r̅e̅g̅U̅p̅}̅−P_{regUp})λ+P_{regUp}≦P_{regUp} (20)

(P̅_̅{̅r̅e̅g̅D̅w̅}̅−P_{regDw})λ+P_{regDw}≦P_{regDw} (21)

(P̅_̅{̅R̅R̅}̅−P_{RR})λ+P_{RR}−P_{RR} (22)

(E̅ₓ̅_̅{̅_̅{̅U̅}̅}̅−Eₓ_{_{U}})λ+Eₓ_{_{U}}≦E̅ₓ̅_̅{̅_̅{̅U̅}̅}̅ (23)

(E̅ₓ̅_̅{̅_̅{̅D̅}̅}̅−Eₓ_{_{D}})λ+Eₓ_{_{D}}≦E̅ₓ̅_̅{̅_̅{̅D̅}̅}̅ (24)

(E̅ₓ̅_̅{̅_̅{̅R̅}̅}̅−Eₓ_{_{R}})λ+Eₓ_{_{R}}≦E̅ₓ̅_̅{̅_̅{̅R̅}̅}̅ (25)

$$λ = min \{ {μ}_{In} , {μ}_{regUp} , {μ}_{regDw} , {μ}_{RR} , {μ}_{{E}_{{x}_{U}}} , {μ}_{{E}_{{x}_{D}}} , {μ}_{{E}_{{x}_{R}}} \} . \qquad ( 26 )$$

Thus, the complete optimal fuzzy formulation is given by:

Maximize λ, (27)

subject to the conditions of equations (3), (4) and (19)-(26), and the following:

Σₜ^{T}^{_{trip,i}}E(FPᵢ(t))·Compᵢ(t)·Efᵢ(t)+SOC_{I,i}≦M_{Ci} (28)

ΣₜE(FPᵢ(t))·Compᵢ(t)·Efᵢ(t)+SOC_{I,i}−Tripᵢ≦M_{Ci} (29)

(MxAPᵢ(t)+POPᵢ(t))·Compᵢ(t)·Efᵢ(t)+SOC_{I,i}≦M_{Ci} (30)

RsRPᵢ(t)≦POPᵢ(t)−MnAPᵢ(t) (31)

(MxAPᵢ(t)+POPᵢ(t))·Compᵢ(t)≦MPᵢ·Avᵢ(t) (32)

SOCfᵢ≧SOCfdᵢ (33)

MxAPᵢ(t)≧0 (34a)

MnAPᵢ(t)≧0 (34b)

RsRPᵢ(t)≧0 (34c)

POPᵢ(t)≧0, (34d)

where an expected value of the energy received by the i-th EV is given by:

E(FPᵢ(t))=MxAPᵢ(t)Eₓ_{_{D}})+POPᵢ(t)−MnAPᵢ(t)Eₓ_{_{U}}RsRPᵢ(t)Eₓ_{_{R}}, (35)

where T_{trip,i} is a time at which the i-th EV makes a commute trip, Compᵢ(t) is a compensation factor to account for unplanned departures of the i-th EV, Efᵢ is the efficiency of a battery charger connected to a battery of the i-th EV, SOC_{I,i} is the initial state of charge of the battery of the i-th EV, M_{Ci} is the maximum charge of the battery of the i-th EV, Tripᵢ is a reduction in the state of charge (SOC) of the battery of the i-th EV as a result of the commute trip, MxAPᵢ(t) is a maximum additional power draw of the i-th EV at time t, POPᵢ(t) is a preferred operating point of the i-th EV at time t, RsRPᵢ(t) is a reduction in power draw of the i-th EV available for spinning reserves, MnAPᵢ(t) is a minimum additional power draw of the i-th EV at time t, MPᵢ is a power rating of the battery charger connected to the battery of the i-th EV, Avᵢ(t) is an availability of the i-th EV for V2G, where Avᵢ(t)=1 if the i-th EV is available for V2G and Avᵢ(t)=0 if the i-th EV is not available for V2G, SOCfᵢ is a final state of charge of the battery of the i-th EV, and SOCfdᵢ is a desired final state of charge of the battery of the i-th EV.

The unexpected EV departure and associated compensation factors are given by:

$$\begin{matrix}{Comp}_{i} ( t ) = 1 + \frac{{Dep}_{i} ( t )}{1 - {Dep}_{i} ( t )} , \\ and & ( 36 ) \\ {EV}_{per} ( t ) = \{ \begin{matrix}1 - {\sum }_{time = 1}^{t} {\sum }_{i} {Dep}_{i} ( time ) & if t < {T}_{trip , i} \\ 1 - {\sum }_{time = {T}_{trip}}^{t} {\sum }_{i} {Dep}_{i} ( time ) & if t \geq {T}_{trip , i}\end{matrix} , & ( 37 )\end{matrix}$$

where Depᵢ(t) is a probability that the i-th EV will depart unexpectedly at hour t, and

R_{Up}(t)=Σᵢ₌₁^{N}MnAPᵢ(t) (38)

R_{Down}(t)=Σᵢ₌₁^{N}MxAPᵢ(t) (39)

R_{RR}Σᵢ₌₁^{N}RsRPᵢ(t), (40)

where N is the total number of EVs.

In this fuzzy optimization, an objective is to maximize the minimum membership of the fuzzy variables. The other costs of the aggregator, such as the charging station infrastructure cost and other operating costs (e.g., communication and personnel costs) are assumed to be fixed irrespective of the daily bid volumes. The optimization formulation is constrained by the battery capacities as incorporated in equations (28)-(30). Constraint (28) ensures the battery is not overcharged before the first commute trip. Constraint (29), accounting for the commute trip, ensures that the battery does not over-charge throughout the day. The constraint in equation (30) ensures that the battery will not overcharge during mid-scheduling period. Equations (31)-(32) are due to the rate limitations. As this formulation is for the whole day, the EV availability and trip times have to be considered. If the EV is not available, then Avᵢ(t)=0 and that particular EV will not participate in providing services that period. If the EV is available on charging station, then Avᵢ(t)=1 and that particular EV will be available for bidding in the market.

There are several ways to forecast the availability of an EV in each hour and the associated unexpected departure probability. One method is to analyze historic data of the EV. At each hour of the day, the EV will have a probability of being plugged in. Weekdays will be more predictable than weekends as people's driving habits are often more routine. With several months' worth of driving data, a weekly driving profile can be made for each EV. For each hour when the probability of being plugged in is greater than 50%, the availability variable, Avᵢ(t), will be assigned a value of 1. The probability that the EV will not be plugged-in for that entire hour will be set as the departure probability, Depᵢ(t). This will allow the aggregator to schedule the EVs based on the drivers' behavior and know how much each EV needs to be under-scheduled so it can be compensated. As the amount of historic data on the EVs grows, the probabilities become more certain. It has been shown that for groups of EVs of at least 10,000, V2G regulation can be scheduled with the same degree of certainty as conventional generators; i.e., the uncertainties associated with the whole group of EVs can be considered deterministic in each hour according to the law of large numbers. Similar methods can be used to predict the amount of energy used in each trip. Because only large groups of EVs are considered in the present formulation, these uncertain values are averaged and treated in a deterministic manner rather than a fuzzy manner, for example.

Equation (33) ensures that the EVs are charged up at the desired level by the end of the charging day. This constraint allows the EV owners to tell the aggregator the minimum SOC that they need. This can be different every day of the week, if desired. Equations (34a-34d) are related to the EV battery capacity and constrain the variable to be non-negative, as only unidirectional bidding is considered. Equation (35) shows that the expected energy received is a function of the bidding parameters i.e. preferred operating point, regulation up/down capacity and responsive reserve capacity. It should be noted that the proposed fuzzy optimization problem presented above is essentially a linear programming problem. The fuzziness is included by means of a membership function for each of the uncertain parameter or variable. To maintain linearity, the membership functions are all chosen to be linear. This model is developed with the assumption that the EV aggregator will be one of many participants in a robust ancillary services market. After the capacities are calculated they will be submitted to the market with a $0/MW bid price. This will ensure that they are accepted when the market clears. The market clearing price will be determined based on the bids of capacities and prices, and the ancillary service requirements. The market will then clear using the current mechanisms used in the major markets such as RIM Interconnection or ERCOT, which currently allow demand resources to participate in ancillary services markets.

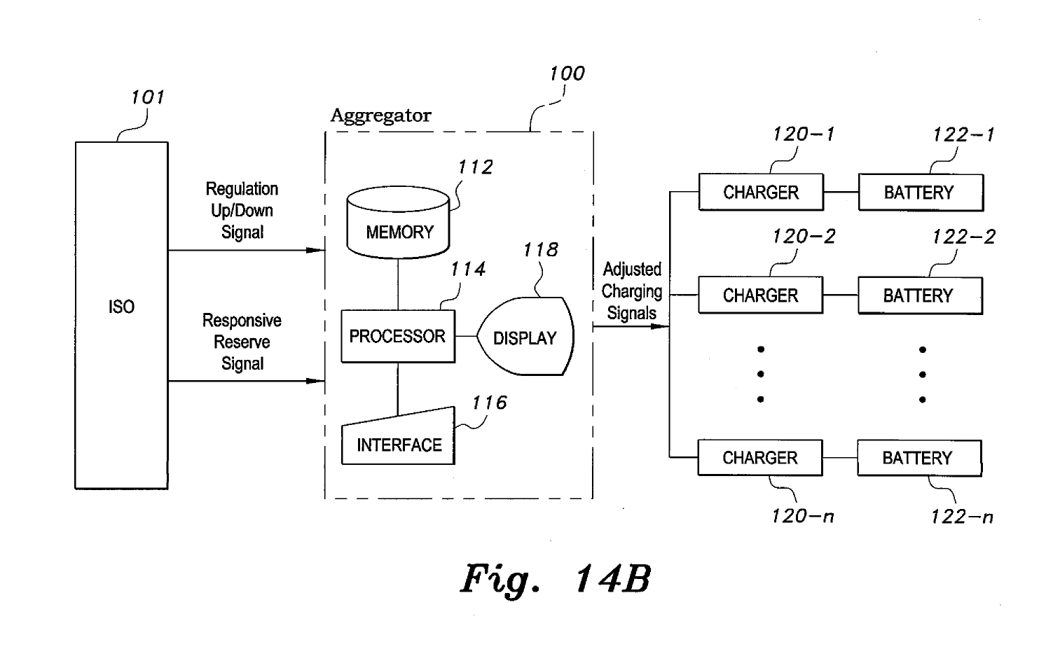

It should be understood that the calculations can be performed by any suitable computer system, such as that diagrammatically shown in FIG. 14B. Data is entered into the aggregator's system 100 via any suitable type of user interface 116, and can be stored in memory 112, which can be any suitable type of computer readable and programmable memory and is preferably a non-transitory, computer readable storage medium. Calculations are performed by processor 114, which can be any suitable type of computer processor and can be displayed to the user on display 118, which can be any suitable type of computer display.

The processor 114 can be associated with, or incorporated into, any suitable type of computing device, for example, a personal computer, a programmable logic controller (PLC), or an application specific integrated circuit (ASIC). The display 118, the processor 114, the memory 112 and any associated computer readable recording media are in communication with one another by any suitable type of data bus, as is well known in the art.

The aggregator's system 100 uses the fuzzy linear programming method for optimizing charging schedules in unidirectional vehicle-to-grid systems, and to calculate the optimal charging times/schedule for the N EVs. As shown in FIG. 14A, the fuzzy optimization is carried out one day ahead of the implementation day by maximizing the objective function λ to determine the scheduled charging rates (POPᵢ) and the ancillary service capacities (MnAPᵢ, MxAPᵢ, and RsRPᵢ) to be provided to the electricity markets at each dispatch period t for each of N electric vehicles. Once the optimization results are obtained, the aggregator sends these results (i.e., POPᵢ, MnAPᵢ, MxAPᵢ, and RsRPᵢ for all dispatch periods) to the ancillary service markets via an independent service operator (ISO) 101.

If the bids are accepted by the market operator 101 (they are usually guaranteed to be accepted, since the aggregator 100 bids these capacities at zero price), the aggregator 100 is required to respond to the system operator's regulation and reserve signals (if any) during real-time operation on implementation day (the day after bidding), as shown in FIG. 14B. During real-time operation, a regulation or a responsive reserve signal might be sent by the operator 101 to the aggregator 100. According to these signals, the aggregator 100 adjusts the scheduled charging rate of each EV proportionally. The adjusted charging signal is transmitted to battery chargers 120-1, 120-2, . . . , 120-N associated with the batteries 122-1, 122-2, . . . , 122-N of the N EVs. The process of adjusting the charging signal in response to a regulation or responsive reserve signal does not require fuzzy logic programming, and may be performed by conventional software known in the art.

Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that can be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable storage media include all computer-readable media, with the sole exception being a transitory, propagating signal.

In order to test the effectiveness of the present fuzzy linear programming method for optimizing charging schedules in unidirectional vehicle-to-grid systems, simulations were performed for a period of three months, from Jul. 21, 2010 to Oct. 20, 2010. All of the simulations were performed on the ERCOT market with a hypothetical group of 10,000 EVs used by commuters. The system was simulated in MATLAB using CVX to solve the optimization problem. Each day of the simulation started at 6 AM and ended at 6 AM on the following day. The final SOC of the EVs on the simulation day were the initial SOC for the next day. Electricity market parameters, such as energy prices, loads, and ancillary service signals, were taken from the ERCOT database for the simulation period. Ancillary service deployments had a five-minute resolution due to the available data, but an EV can follow the deployment signals of much higher resolution. The day-ahead load of the ERCOT system was generated, though it should be noted that the day-ahead system load is not needed to perform the optimization. It was used here only to assess the impact of the proposed strategy on the system total load, for example.

The electricity market parameters for the day of implementation were forecast using autoregressive integrated moving average (ARIMA) models. These include regulation up/down prices, responsive reserve prices, expected regulation up/down deployments, and expected responsive reserve deployments. The hourly expected deployments of the ancillary service capacity are calculated for the historic data and then the forecast was performed using ARIMA. Using historical data of both actual and forecast parameter values, the mean absolute percentage error (MAPE) between the forecast and actual values were calculated in order to incorporate these forecasting inaccuracies into the fuzzy formulation. The MAPEs during the three-month period are shown in the second column of Table 1. Using these MAPEs and the ARIMA-forecast market parameters for the implementation day, the minimum and maximum limits of each fuzzy variable are obtained. As an example, columns 3-5 of Table 1 show the forecast, maximum and minimum limits for Hour 17 of Aug. 1, 2010.

TABLE 1
MAPE of Forecast Quantities Over Simulated Period

| | | Data for Hour 17 | | |
|---|---|---|---|---|
| | | of Aug. 1^{st}, 2010 | | |
| Electricity Market Parameters | MAPE | Forecast | Max | Min |
| Regulation Up Prices | 8.3% | 32.45 | 35.1 | 29.7 |
| Regulation Down Prices | 9.6% | 9.01 | 9.87 | 8.14 |
| Responsive Reserve Prices | 6.7% | 21.3 | 22.7 | 19.9 |
| Regulation Up Deployments | 28.5% | 0.32 | 0.41 | 0.23 |
| Regulation Down Deployments | 31.3% | 0.239 | 0.31 | 0.16 |
| Responsive Reserve Deployments | 24.8% | 0.001 | 1.2 × | 7.5 × |
| | | | 10⁻³ | 10⁻⁴ |

The maximum and minimum limits for In are determined as a pre-defined percentage of the deterministic profits. Unless stated otherwise, these limits are set at ±10% of the deterministic profits. In this simulation study, three different kinds of EVs available in the market were considered: the Nissan Leaf®, the Mitsubishi® i-MiEV and the Tesla® Model S. Among this hypothetical group, it was assumed that 50% of the EVs were the Nissan Leaf®, 20% were the Mitsubishi® i-MiEV and 30% were the Tesla® Model S. It was also assumed that each EV had a charging efficiency of 90%. All the EVs were charged from a 240V supply. As a conservative estimate of EV owner behavior, the final desired SOC was set to 99% for each EV for each day. In reality, some owners will not require such a high final SOC. Relaxing the constraint will typically only increase the profits, for example.

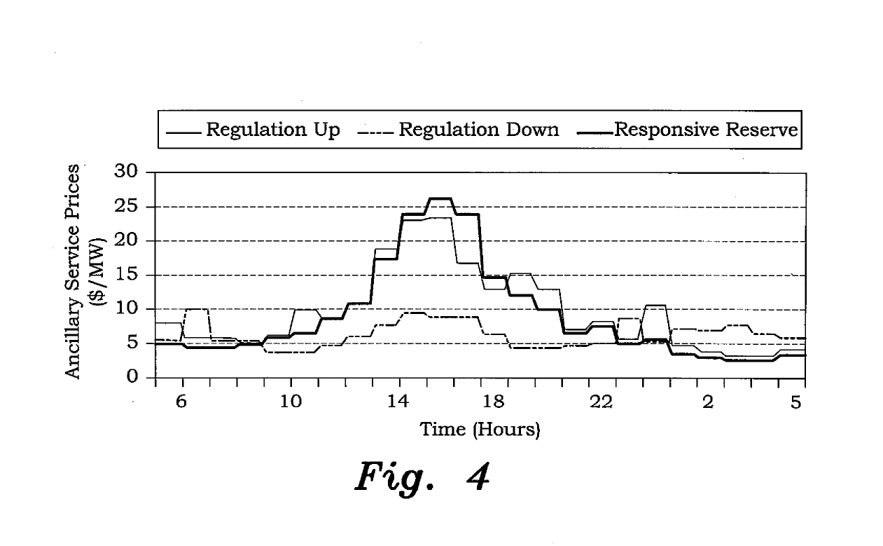

Driving profiles were created using the 2009 National Household Travel Survey (NHTS) data. The NHTS data was filtered for commuter vehicle trips in urban Texas. From the data set, probability distributions of morning commute times, evening commute times, and other trip times were found. Probability distributions for trip distances were also generated from the data. Each EV was assigned a random driving profile from the calculated probability distributions. With this profile came the availability and the unexpected departure probability for each hour, as well as the expected trip distance. Since the hypothetical group of EVs consists of 10,000 cars, there was a sufficient number to treat the combined probabilities in a deterministic manner for compensation. FIG. 3 shows the average percentage of EVs available for providing V2G services in a 24 hour period. In this study, 100 different EV driving profiles were considered.

Two types of bidding algorithms were simulated and compared: a conventional deterministic algorithm and the present fuzzy linear programming (FLP) method. The main difference between the deterministic algorithm and the FLP method is the incorporation of electricity market uncertainties in the model. For each algorithm, the expected day-ahead aggregator profits are obtained by evaluating the corresponding objective function. The expected profits were calculated using the forecast market values. To further assess the effectiveness of the present FLP formulation, the actual aggregator profits on the bidding day were calculated for both the deterministic and FLP algorithms by simulating the actual (realized) driving, charging, and ancillary deployments for the EVs with an ancillary service algorithm; i.e., the actual aggregator profits were calculated using the actual (realized) market parameters, such as energy price, ancillary service prices, and regulation deployments.

Unless stated otherwise, the energy cost for the EV owner is assigned to be fixed at β=$0.05/kilowatt (kW)-hour. It should be noted that the actual average energy price paid by the residential customers in the year 2010 in the ERCOT market was $0.1281 kW-hour. This low cost of energy for EV charging is offered in order to attract the EV owners to allow the aggregator to control their charging. With this fixed energy cost, the EV owners will not be exposed to the energy price variations.

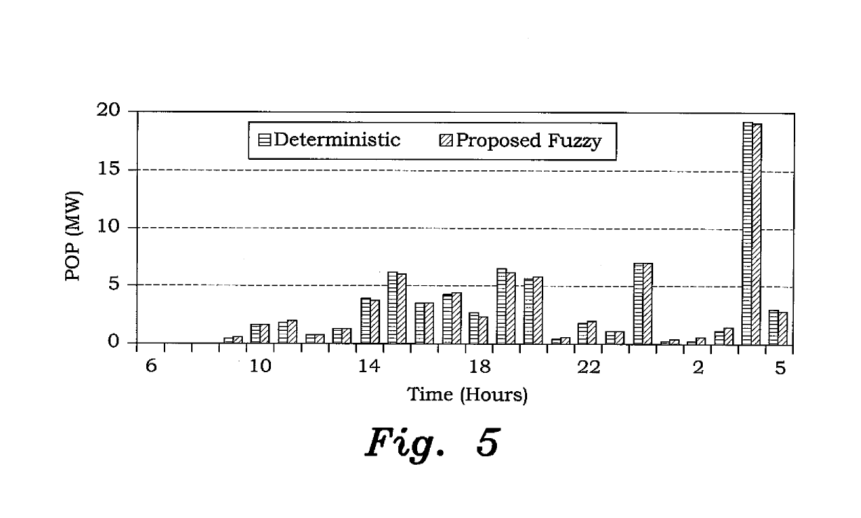

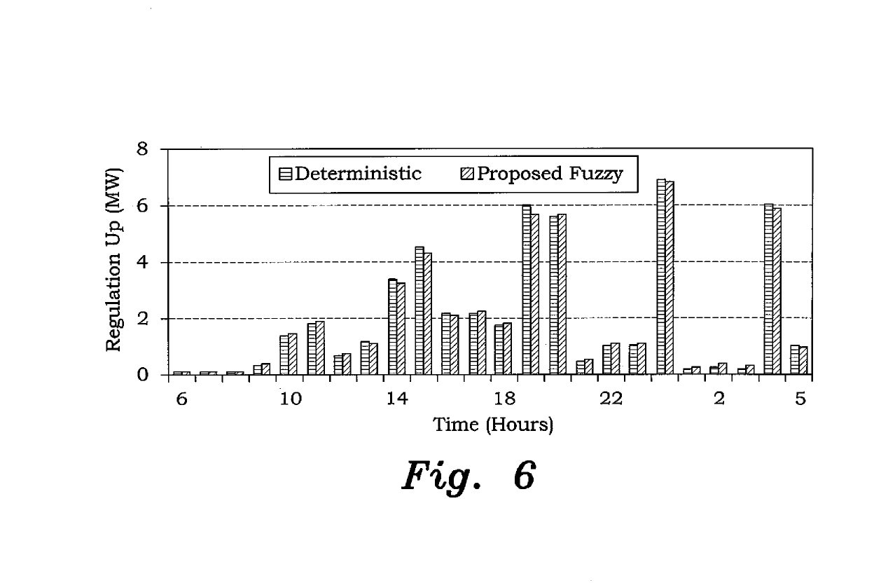

The charging profiles and the average ancillary services capacities provided by each algorithm were compared for the three-month period. The average ancillary service prices for three months are shown in FIG. 4. These values were obtained from the ERCOT data archives. It should be noted that all the prices are usually high in the late afternoon period. The POP for an average day is shown in FIG. 5. Both algorithms almost follow the same pattern and keep the POP to a low value in the early six hours. In the middle of the day they set the POP at relatively higher values. This is because of higher regulation up prices. For the same reason, the average POP in hour 24 is observed to be relatively high. It should be noted that both algorithms set the POP to be highest just before the end of the simulation day. This is because if the EVs are fully charged earlier, they will not be able to provide any of the ancillary services later.

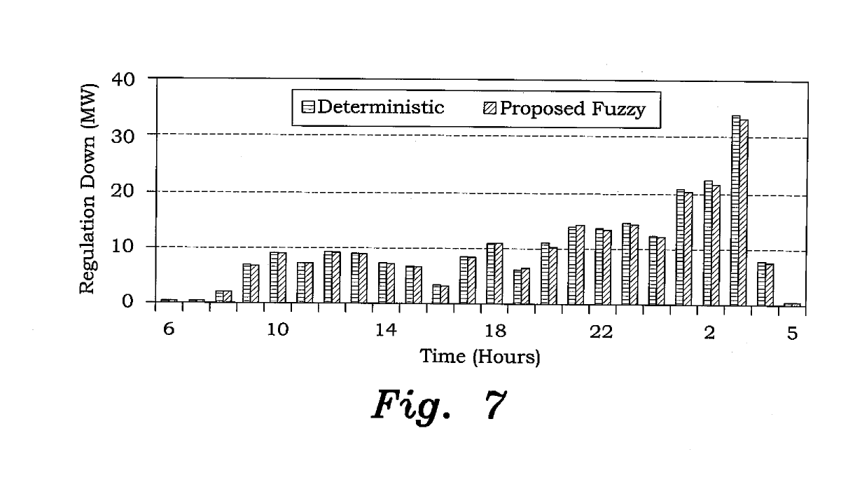

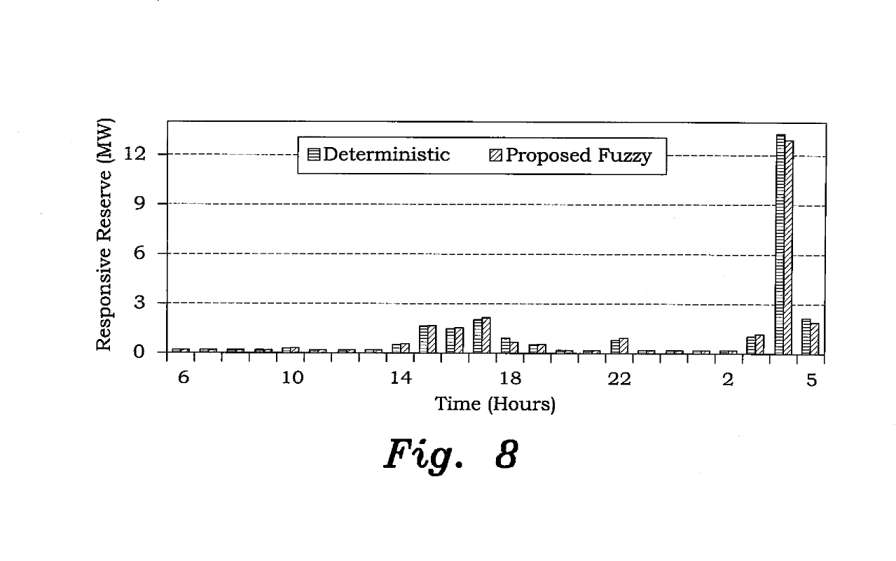

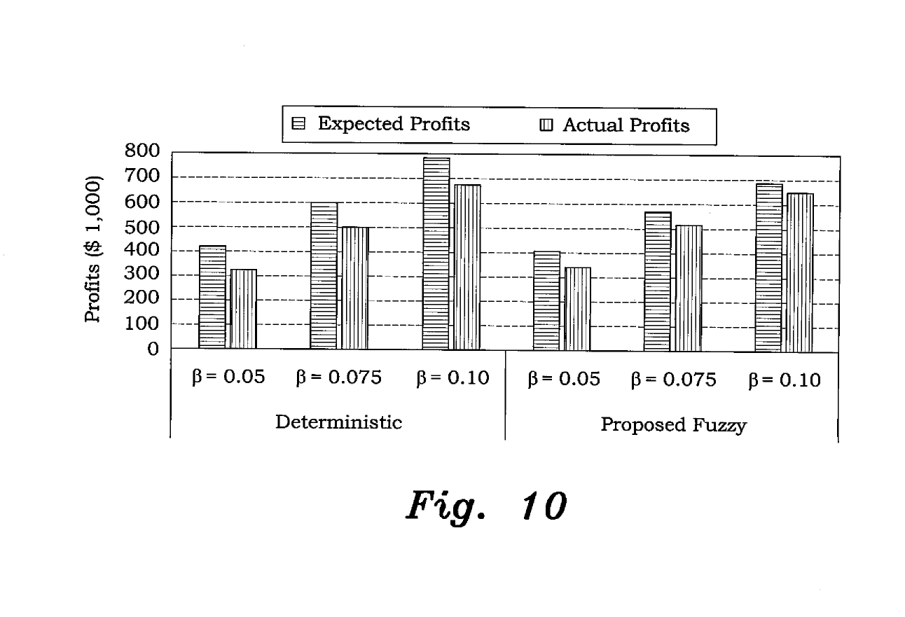

The ancillary services capacities provided by each algorithm are shown in FIGS. 6-8. FIG. 6 shows that average regulation up capacities are adjusted mainly in response to the average regulation up prices. A similar trend is observed relating the average regulation down capacities, as seen in FIG. 7, to the average regulation down prices. However, it should be noted that regulation down capacities provided to the market are on average higher than the regulation up capacities. This is due to the fact that regulation down can be bid with the POP at zero which adds less energy to the battery than regulation up, as seen in FIG. 9. At the start of the day before 8 AM, the regulation down bids are typically almost zero because of shortage of remaining EV battery capacities, for example.

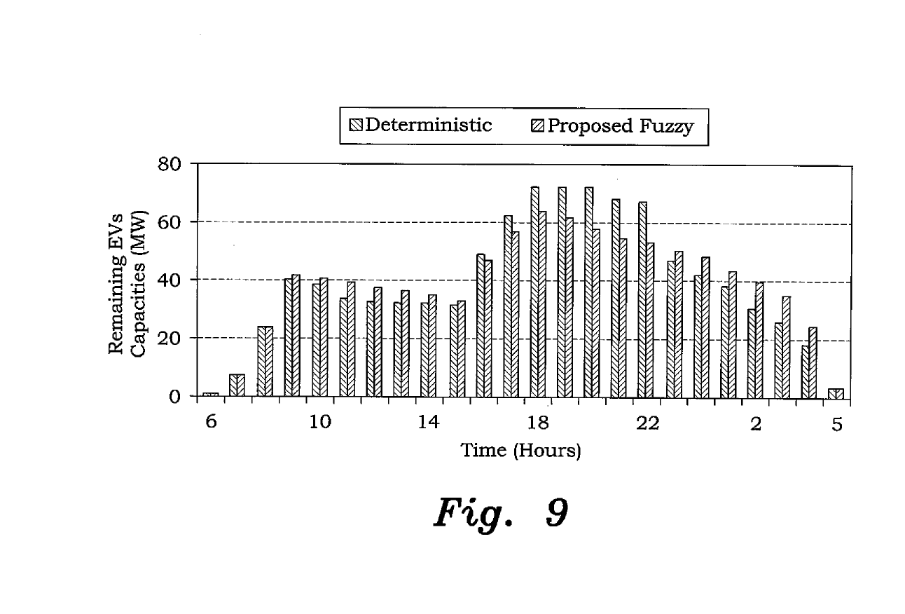

The responsive reserve capacity is shown in FIG. 8. It can be seen that responsive reserve capacity is bid in the afternoon due to the high reserve price. However, this capacity is low because of the limited POP schedule and the regulation up capacity bid during this period. At 4:00, it is observed that a high reserve capacity is bid. This is due to the high POP scheduled at this hour. It should be noted that due to the inclusion of the final SOC constraint given by equation (33), the algorithm sets high POP at 4:00, i.e., before the last hour. This is to minimize the likelihood that the desired final SOC is not met. If this was left for the last hour, i.e., 5:00, and the responsive reserves were called upon, more EV batteries would be at risk of failing to meet their desired final SOC.

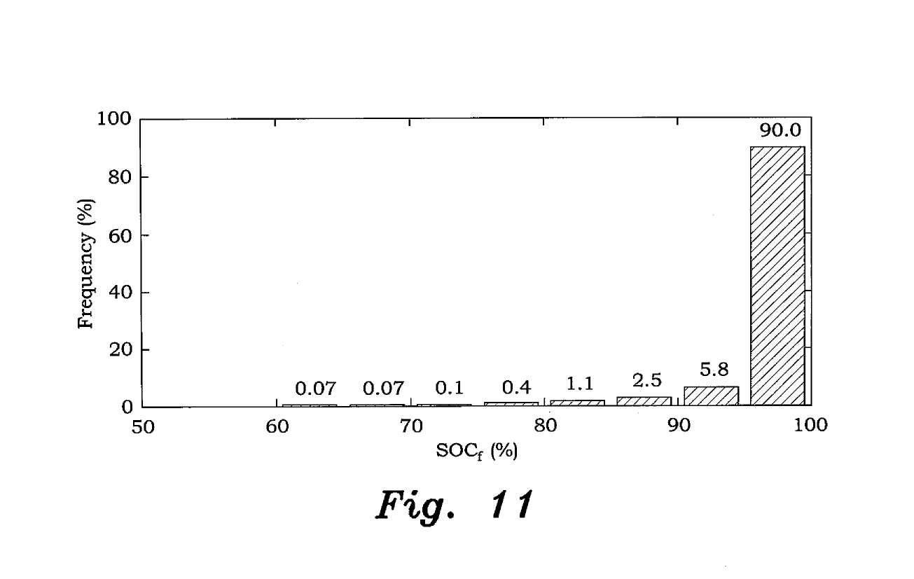

The efficacy of the present method has also been tested from the standpoints of the aggregator, the system operator, and the EV owners. FIG. 10 shows a comparison of aggregator total expected and actual profits over the simulation period for the deterministic and present FLP method for different values of β. For β=$0.05/kW-hour, the expected aggregator profits come out to be $420,990 for the deterministic case, which is 2.98% higher than the expected FLP profits. However, the actual (realized) profits obtained by the FLP algorithm are 5.84% higher than those of the deterministic actual profits. On the actual day, the fuzzy algorithm performs better than the deterministic algorithm. This also indicates the importance of including the market uncertainties in the optimization. Ignoring those uncertainties can result in misleading expected profits that cannot be realized. In addition, these results indicate that the aggregator's profits can be further increased by charging the EV owners at higher energy rates. It should be noted that all the rates considered here are still below the average energy price paid by residential customers, i.e., $0.128/kW-hour, for the system under study during the test period. Further, the impact of changing the fuzzy income limits (i.e., In and I̅n̅) on the profits is shown in Table 2. It should be noted that the income limits need to be pre-determined before the optimization is carried out. These results show that setting these limits to ±10% gives rise to the maximum profits, for example.

TABLE 2
Sensitivity of Profits To Fuzzy Income Limits

| | Deterministic | Fuzzy ±5% | Fuzzy ±10% | Fuzzy ±15% | Fuzzy ±20% |
|---|---|---|---|---|---|
| Expected Profits | 420.99 | 406.0 | 408.4 | 400.1 | 395.8 |
| Actual Profits | 324.29 | 342.6 | 343.2 | 340.7 | 339.0 |

From the power system perspective, it is desirable that the EVs should not burden the power system network due to their additional load. Statistics of the overall average load increase and the average load increase during the peak hours using both algorithms are shown in Table 3. The load increases are more or less the same using both algorithms. Load increase during peak hours is lower, on average, than the overall load increase. This is desirable as it indicates that both algorithms apply reduced EV charging rates during peak hours compared with those of off-peak hours. It should be noted that the maximum load increase during peak hours, which is less than 10 MW by either of the algorithms, is insignificant as compared with the average load of 15,845 MW and peak load of 22,178 MW in the ERCOT system during this simulation.

TABLE 3
Load Increase Statistics

| | | Deterministic | Fuzzy |
|---|---|---|---|
| Load Increase in | Average | 3.44 | 3.44 |
| General (MW) | Standard Deviation | 6.23 | 6.14 |
| Load Increase During | Average | 1.92 | 1.89 |
| Peak Hours (MW) | Standard Deviation | 2.74 | 2.69 |
| | Maximum | 9.89 | 9.93 |

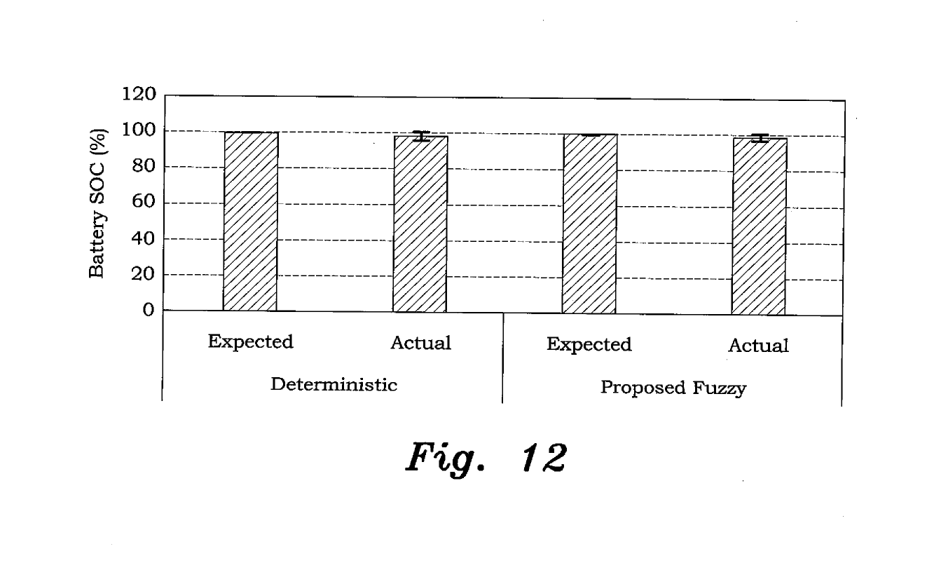

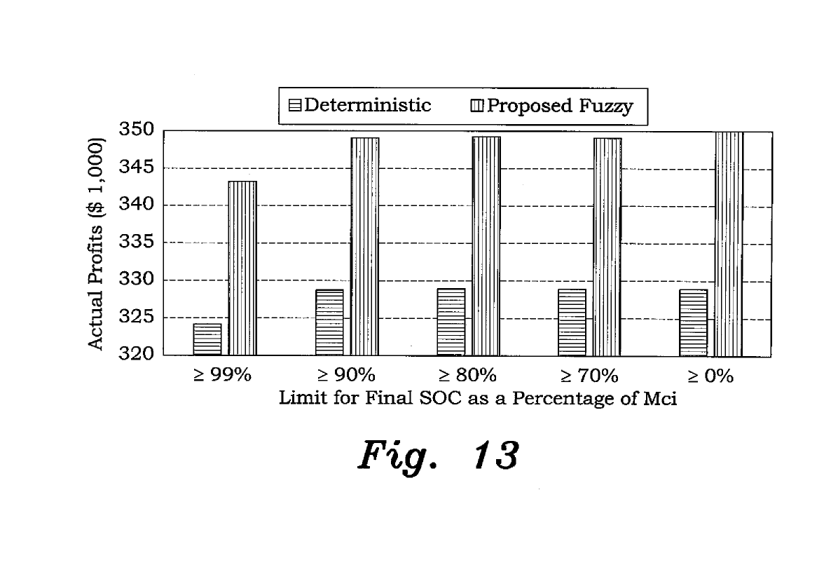

It is important that the EV batteries get charged to the desired final SOC by the end of the charging period. FIG. 11 shows a histogram of the actual SOCf during the test period. These results indicate that SOCf is less than 90% of the battery capacity for only 4% of the time, and less than 80% for less than for only 0.7% of the time. In addition, FIG. 12 shows the average SOCf for both the deterministic and fuzzy algorithms. The averages of actual SOCf are 97.96% and 98.50% for the deterministic and fuzzy algorithms, respectively. The corresponding standard deviations in the two cases are 2.35% and 2.03% only.

These results, though very encouraging, can be improved even further by assigning higher charging priority to the EVs with low SOC. This likely would not affect the market bidding process or the profits, but it can help eliminate the small percentage of occurrences at which SOCf does not reach 99% on the actual day.

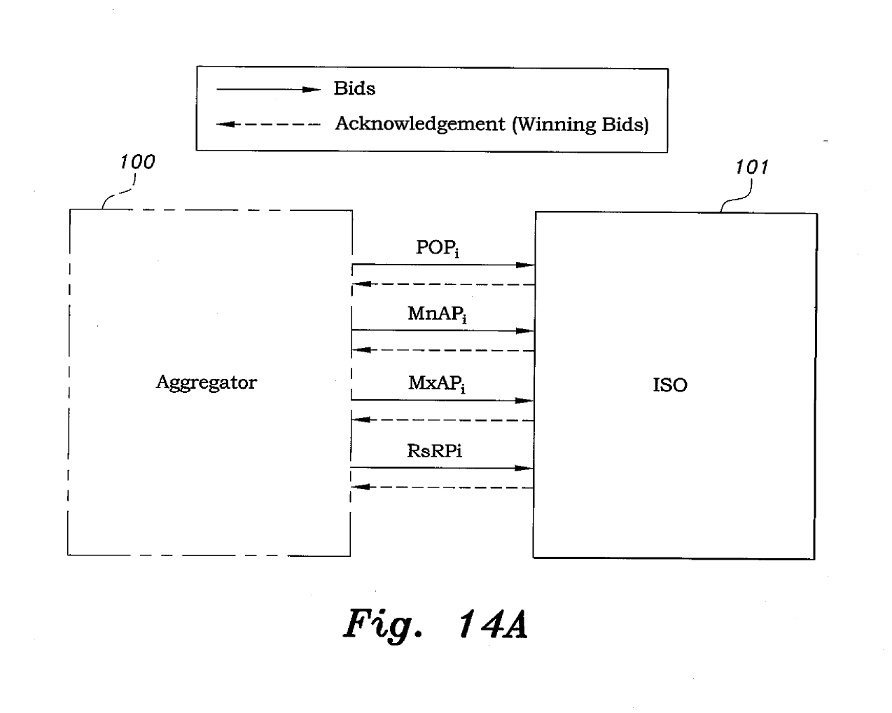

Finally, the sensitivity of the actual profits to the level of final desired SOC was carried out. As indicated in FIG. 13, the actual aggregator profits increase as the final desired SOC by the EV owners decrease. This is to be expected as lower SOCfd leaves the aggregator with greater flexibility, i.e., it results in an optimization problem with a more relaxed constraint. It should be noted that the first two columns to the right belong to the case where no SOCfd limit is imposed. This defines an upper bound of the actual profits.

It is to be understood that the present invention is not limited to the embodiments described above, but encompasses any and all embodiments within the scope of the following claims.

We claim:

1. A fuzzy linear programming method for optimizing charging schedules in unidirectional vehicle-to-grid systems, comprising:
maximizing a fuzzy objective function, λ, to determine scheduled charging rates and ancillary service capacities to be provided to the electricity markets at each dispatch period t for each of N electric vehicles, where
$$λ = min \{ {μ}_{In} , {μ}_{regUp} , {μ}_{regDw} , {μ}_{RR} , {μ}_{{E}_{{x}_{U}}} , {μ}_{{E}_{{x}_{D}}} , {μ}_{{E}_{{x}_{R}}} \} ,$$
and where the fuzzy objective function λ is maximized subject to the following conditions:
(I̅n̅−In)λ+In≦I̅n̅,
(P̅_̅{̅r̅e̅g̅U̅p̅}̅−P_{regUp})λ+P_{regUp}≦P_{regUp},
(P̅_̅{̅r̅e̅g̅D̅w̅}̅−P_{regDw})λ+P_{regDw}≦P_{regDw},
(P̅_̅{̅R̅R̅}̅−P_{RR})λ+P_{RR}≦P_{RR},
(E̅ₓ̅_̅{̅_̅{̅U̅}̅}̅−Eₓ_{_{U}})λ+Eₓ_{_{U}}≦E̅ₓ̅_̅{̅_̅{̅U̅}̅}̅,
(E̅ₓ̅_̅{̅_̅{̅D̅}̅}̅−Eₓ_{_{D}})λ+Eₓ_{_{D}}≦E̅ₓ̅_̅{̅_̅{̅D̅}̅}̅, and
(E̅ₓ̅_̅{̅_̅{̅R̅}̅}̅−Eₓ_{_{R}})λ+Eₓ_{_{R}}−E̅ₓ̅_̅{̅_̅{̅R̅}̅}̅,
where In is a fuzzy objective function representing an aggregator income, such that In=[Σₜ(P_{regUp}·R_{Up}+P_{regDw}·R_{Down}+P_{RR}·R_{RR})+βΣᵢΣₜ(E(FPᵢ))]EVₚₑᵣ(t), β is a fixed energy price rate for an electric vehicle owner, P_{regUp} is a market price of regulation up, P_{regDw} is a market price of regulation down, R_{Up} is a regulation up capacity, R_{Down} is a regulation down capacity, P_{RR} is a market price of response reserves, R_{RR} is a response reserve capacity, E( ) represents an expectation value, FPᵢ is a final power draw of the i-th electric vehicle, EVₚₑᵣ(t) is an expected percentage of electric vehicles remaining to perform vehicle-to-grid charging at hour t, I̅n̅ is an upper limit of the aggregator income, In is a lower limit of the aggregator income, P̅_̅{̅r̅e̅g̅U̅p̅}̅ is an upper limit of the market price of regulation up, P_{regUp} is a lower limit of the market price of regulation up, P̅_̅{̅r̅e̅g̅D̅w̅}̅ is an upper limit of the market price of regulation down, P_{regDw} is a lower limit of the market price of regulation down, P̅_̅{̅R̅R̅}̅ is an upper limit of the market price of response reserves, P_{RR} is a lower limit of the market price of response reserves, Eₓ_{_{U}} is an expected percentage of regulation up deployments, E̅ₓ̅_̅{̅_̅{̅U̅}̅}̅ is an upper limit of the expected percentage of regulation up deployments, Eₓ_{_{U}} is a lower limit of the expected percentage of regulation up deployments, Eₓ_{_{D}} is an expected percentage of regulation down deployments, E̅ₓ̅_̅{̅_̅{̅D̅}̅}̅ is an upper limit of the expected percentage of regulation down deployments, Eₓ_{_{D}} is a lower limit of the expected percentage of regulation down deployments, Eₓ_{_{R}} is an expected percentage of response reserve deployment, E̅ₓ̅_̅{̅_̅{̅R̅}̅}̅ is an upper limit of the expected percentage of response reserve deployment, Eₓ_{_{R}} is a lower limit of the expected percentage of response reserve deployment, and
$${μ}_{In} , {μ}_{regUp} , {μ}_{regDw} , {μ}_{RR} , {μ}_{{E}_{{x}_{U}}} , {μ}_{{E}_{{x}_{D}}} , {μ}_{{E}_{{x}_{R}}}$$
are, respectively, membership functions for aggregator income, market price of regulation up, market price of regulation down, price of response reserve, expected percentage of regulation up deployments, expected percentage of regulation down deployments, and expected percentage of response reserve deployment, where
$${μ}_{In} = \{ \begin{matrix}0 & for In \leq \underline{In} \\ \frac{In - \underline{In}}{\overline{In} - \underline{In}} & for \underline{I n} \leq In \leq \overline{In} \\ 1 & for In \geq \overline{In} \end{matrix} , \\ {μ}_{regUp} = \{ \begin{matrix}0 & for {P}_{regUp} \leq \underline{{P}_{regUp}} \\ \frac{{P}_{regUp} - \underline{{P}_{regUp}}}{\overline{{P}_{regUp}} - \underline{{P}_{regUp}}} & for \underline{{P}_{regUp}} \leq {P}_{regUp} \leq \overline{{P}_{regUp}} \\ 1 & for {P}_{regUp} \geq \overline{{P}_{regUp}}\end{matrix} , \\ {μ}_{regDw} = \{ \begin{matrix}0 & for {P}_{regDw} \leq \underline{{P}_{regDw}} \\ \frac{{P}_{regDw} - \underline{{P}_{regDw}}}{\overline{{P}_{regDw}} - \underline{{P}_{regDw}}} & for \underline{{P}_{regDw}} \leq {P}_{regDw} \leq \overline{{P}_{regDw}} \\ 1 & for {P}_{regDw} \geq \overline{{P}_{regDw}}\end{matrix} , \\ {μ}_{RR} = \{ \begin{matrix}0 & for {P}_{RR} \leq \underline{{P}_{RR}} \\ \frac{{P}_{RR} - \underline{{P}_{RR}}}{\overline{{P}_{RR}} - \underline{{P}_{RR}}} & for \underline{{P}_{RR}} \leq {P}_{RR} \leq \overline{{P}_{RR}} \\ 1 & for {P}_{RR} \geq \overline{{P}_{RR}}\end{matrix} , \\ {μ}_{{E}_{{x}_{U}}} = \{ \begin{matrix}1 & for {E}_{{x}_{U}} \leq \underline{{E}_{{x}_{U}}} \\ \frac{\overline{{E}_{{x}_{U}}} - {E}_{{x}_{U}}}{\overline{{E}_{{x}_{U}}} - \underline{{E}_{{x}_{U}}}} & for \underline{{E}_{{x}_{U}}} \leq {E}_{{x}_{U}} \leq \overline{{E}_{{x}_{U}}} \\ 0 & for {E}_{{x}_{U}} \geq \overline{{E}_{{x}_{U}}}\end{matrix} , \\ {μ}_{{E}_{{x}_{D}}} = \{ \begin{matrix}1 & for {E}_{{x}_{D}} \leq \underline{{E}_{{x}_{D}}} \\ \frac{\overline{{E}_{{x}_{D}}} - {E}_{{x}_{D}}}{\overline{{E}_{{x}_{D}}} - \underline{{E}_{{x}_{D}}}} & for \underline{{E}_{{x}_{D}}} \leq {E}_{{x}_{D}} \leq \overline{{E}_{{x}_{D}}} \\ 0 & for {E}_{{x}_{D}} \geq \overline{{E}_{{x}_{D}}}\end{matrix} , \\ {μ}_{{E}_{{x}_{R}}} = \{ \begin{matrix}1 & for {E}_{{x}_{R}} \leq \underline{{E}_{{x}_{R}}} \\ \frac{\overline{{E}_{{x}_{R}}} - {E}_{{x}_{R}}}{\overline{{E}_{{x}_{R}}} - \underline{{E}_{{x}_{R}}}} & for \underline{{E}_{{x}_{R}}} \leq {E}_{{x}_{R}} \leq \overline{{E}_{{x}_{R}}} \\ 0 & for {E}_{{x}_{R}} \geq \overline{{E}_{{x}_{R}}}\end{matrix} ,$$
and further subject to a cost function C=Σᵢ Σₜ(E(FPᵢ))·P(t)·EVₚₑᵣ(t), where P(t) is an energy market price at time t, and further subject to the following constraints:
Σₜ^{T}^{_{trip,i}}E(FPᵢ(t))·Compᵢ(t)·Efᵢ(t)+SOC_{I,i}≦M_{Ci},
ΣₜE(FPᵢ(t))·Compᵢ(t)·Efᵢ(t)+SOC_{I,i}−Tripᵢ≦M_{Ci},
(MxAPᵢ(t)+POPᵢ(t)·Compᵢ(t)·Efᵢ(t)+SOC_{I,i}≦M_{Ci},
RsRPᵢ(t)≦POPᵢ(t)−MnAPᵢ(t),
(MxAPᵢ(t)+POPᵢ(t))·Compᵢ(t)≦MPᵢ·Avᵢ(t),
SOCfᵢ≧SOCfdᵢ,
MxAPᵢ(t)≧0,
MnAPᵢ(t)≧0,
RsRPᵢ(t)≧0, and
POPᵢ(t)≧0,
where the expected value of the energy received by the i-th electric vehicle is given by E(FPᵢ(t))=MxAPᵢ(t)Eₓ_{_{D}}+POPᵢ(t)−MnAPᵢ(t)Eₓ_{_{U}}−RsRPᵢ(t)Eₓ_{_{R}}, T_{trip,i} is a time at which the i-th electric vehicle makes a commute trip, Compᵢ(t) is a compensation factor to account for unplanned departures of the i-th electric vehicle, Efᵢ is the efficiency of a battery charger connected to a battery of the i-th electric vehicle, SOC_{I,i} is the initial state of charge of the battery of the i-th electric vehicle, M_{Ci} is the maximum charge of the battery of the i-th electric vehicle, Tripᵢ is a reduction in the state of charge of the battery of the i-th electric vehicle as a result of the commute trip, MxAPᵢ(t) is a maximum additional power draw of the i-th electric vehicle at time t, POPᵢ(t) is a preferred operating point of the i-th electric vehicle at time t, RsRPᵢ(t) is a reduction in power draw of the i-th electric vehicle available for spinning reserves, MnAPᵢ(t) is a minimum additional power draw of the i-th electric vehicle at time t, MPᵢ is a power rating of the battery charger connected to the battery of the i-th electric vehicle, Avᵢ(t) is an availability of the i-th electric vehicle for vehicle-to-grid charging, where Avᵢ(t)=1 if the i-th electric vehicle is available for vehicle-to-grid charging and Avᵢ(t)=0 if the i-th electric vehicle is not available for vehicle-to-grid charging, SOCfᵢ is a final state of charge of the battery of the i-th electric vehicle, and SOCfdᵢ is a desired final state of charge of the battery of the i-th electric vehicle, and
$${Comp}_{i} ( t ) = 1 + \frac{{Dep}_{i} ( t )}{1 - {Dep}_{i} ( t )}$$
$$and$$
$${EV}_{per} ( t ) = \{ \begin{matrix}1 - {\sum }_{time = 1}^{t} {\sum }_{i} {Dep}_{i} ( time ) & if t < {T}_{trip , i} \\ 1 - {\sum }_{time = {T}_{trip}}^{t} {\sum }_{i} {Dep}_{i} ( time ) & if t \geq {T}_{trip , i}\end{matrix} ,$$
where Depᵢ(t) is a probability that the i-th electric vehicle will depart unexpectedly at hour t, and R_{Up}(t)=Σᵢ₌₁^{N}MnAPᵢ(t), R_{Down}(t)=Σᵢ₌₁^{N}MxAPᵢ(t) and R_{RR}(t)=Σᵢ₌₁^{N}RsRPᵢ(t); and
transmitting a charging signal to the i-th battery charger in communication with the battery of the i-th electric vehicle during real-time operation in response to a system operator's regulation or responsive reserve signal.

2. A computer software product that includes a non-transitory storage medium readable by a processor, the non-transitory storage medium having stored thereon a set of instructions for performing a fuzzy linear programming method for optimizing charging schedules in unidirectional vehicle-to-grid systems, the instructions comprising:
(a) a first set of instructions which, when loaded into main memory and executed by the processor, causes the processor to maximize a fuzzy objective function λ, where
$$λ = min \{ {μ}_{In} , {μ}_{regUp} , {μ}_{regDw} , {μ}_{RR} , {μ}_{{E}_{{x}_{U}}} , {μ}_{{E}_{{x}_{D}}} , {μ}_{{E}_{{x}_{R}}} \} ,$$
to determine optimal charging time schedules and ancillary service capacities 0 for an i-th electric vehicle of N electric vehicles, where the fuzzy objective function λ is maximized subject to the following conditions:
(I̅n̅−In)λ+In≦In,
(P̅_̅{̅r̅e̅g̅U̅p̅}̅−P_{regUp})λ+P_{regUp}≦P_{regUp},
(P̅_̅{̅r̅e̅g̅D̅w̅}̅−P_{regDw})λ+P_{regDw}≦P_{regDw},
(P̅_̅{̅R̅R̅}̅−P_{RR})λ+P_{RR}≦P_{RR},
(E̅ₓ̅_̅{̅_̅{̅U̅}̅}̅−Eₓ_{_{U}})λ+Eₓ_{_{U}}≦E̅ₓ̅_̅{̅_̅{̅U̅}̅}̅,
(E̅ₓ̅_̅{̅_̅{̅D̅}̅}̅−Eₓ_{_{D}})λ+Eₓ_{_{D}}≦E̅ₓ̅_̅{̅_̅{̅D̅}̅}̅, and
(E̅ₓ̅_̅{̅_̅{̅R̅}̅}̅−Eₓ_{_{R}})λ+Eₓ_{_{R}}≦E̅ₓ̅_̅{̅_̅{̅R̅}̅}̅,̅
where In is a fuzzy objective function representing an aggregator income, such that In=[Σₜ(P_{regUp}·R_{Up}+P_{regDw}·R_{Down}+P_{RR}·R_{RR})+βΣᵢΣₜ(E(FPᵢ))]·EVₚₑᵣ(t), β is a fixed energy price rate for an electric vehicle owner, P_{regUp} is a market price of regulation up, P_{regDw} is a market price of regulation down, R_{Up} is a regulation up capacity, R_{Down} is a regulation down capacity, P_{RR} is a market price of response reserves, R_{RR} is a response reserve capacity, E( ) represents an expectation value, FPᵢ is a final power draw of the i-th electric vehicle, EVₚₑᵣ(t) is an expected percentage of electric vehicles remaining to perform vehicle-to-grid charging at hour t, I̅n̅ is an upper limit of the aggregator income, In is a lower limit of the aggregator income, P̅_̅{̅r̅e̅g̅U̅p̅}̅ is an upper limit of the market price of regulation up, P_{regUp} is a lower limit of the market price of regulation up, P̅_̅{̅r̅e̅g̅D̅w̅}̅ is an upper limit of the market price of regulation down, P_{regDw} is a lower limit of the market price of regulation down, P̅_̅{̅R̅R̅}̅ is an upper limit of the market price of response reserves, P_{RR} is a lower limit of the market price of response reserves, Eₓ_{_{U}} is an expected percentage of regulation up deployments, E̅ₓ̅_̅{̅_̅{̅U̅}̅}̅ is an upper limit of the expected percentage of regulation up deployments, Eₓ_{_{U}} is a lower limit of the expected percentage of regulation up deployments, Eₓ_{_{D}} is an expected percentage of regulation down deployments, E̅ₓ̅_̅{̅_̅{̅D̅}̅}̅ is an upper limit of the expected percentage of regulation down deployments, Eₓ_{_{D}} is a lower limit of the expected percentage of regulation down deployments, Eₓ_{_{R}} is an expected percentage of response reserve deployment, E̅ₓ̅_̅{̅_̅{̅R̅}̅}̅ is an upper limit of the expected percentage of response reserve deployment, Eₓ_{_{R}} is a lower limit of the expected percentage of response reserve deployment, and
$${μ}_{In} , {μ}_{regUp} , {μ}_{regDw} , {μ}_{RR} , {μ}_{{E}_{{x}_{U}}} , {μ}_{{E}_{{x}_{D}}} , {μ}_{{E}_{{x}_{R}}}$$
are, respectively, membership functions for aggregator income, market price of regulation up, market price of regulation down, price of response reserve, expected percentage of regulation up deployments, expected percentage of regulation down deployments, and expected percentage of response reserve deployment, where
$${μ}_{In} = \{ \begin{matrix}0 & for In \leq \underline{In} \\ \frac{In - \underline{In}}{\overline{In} - \underline{In}} & for \underline{I n} \leq In \leq \overline{In} \\ 1 & for In \geq \overline{In} \end{matrix} , \\ {μ}_{regUp} = \{ \begin{matrix}0 & for {P}_{regUp} \leq \underline{{P}_{regUp}} \\ \frac{{P}_{regUp} - \underline{{P}_{regUp}}}{\overline{{P}_{regUp}} - \underline{{P}_{regUp}}} & for \underline{{P}_{regUp}} \leq {P}_{regUp} \leq \overline{{P}_{regUp}} \\ 1 & for {P}_{regUp} \geq \overline{{P}_{regUp}}\end{matrix} , \\ {μ}_{regDw} = \{ \begin{matrix}0 & for {P}_{regDw} \leq \underline{{P}_{regDw}} \\ \frac{{P}_{regDw} - \underline{{P}_{regDw}}}{\overline{{P}_{regDw}} - \underline{{P}_{regDw}}} & for \underline{{P}_{regDw}} \leq {P}_{regDw} \leq \overline{{P}_{regDw}} \\ 1 & for {P}_{regDw} \geq \overline{{P}_{regDw}}\end{matrix} , \\ {μ}_{RR} = \{ \begin{matrix}0 & for {P}_{RR} \leq \underline{{P}_{RR}} \\ \frac{{P}_{RR} - \underline{{P}_{RR}}}{\overline{{P}_{RR}} - \underline{{P}_{RR}}} & for \underline{{P}_{RR}} \leq {P}_{RR} \leq \overline{{P}_{RR}} \\ 1 & for {P}_{RR} \geq \overline{{P}_{RR}}\end{matrix} , \\ {μ}_{{E}_{{x}_{U}}} = \{ \begin{matrix}1 & for {E}_{{x}_{U}} \leq \underline{{E}_{{x}_{U}}} \\ \frac{\overline{{E}_{{x}_{U}}} - {E}_{{x}_{U}}}{\overline{{E}_{{x}_{U}}} - \underline{{E}_{{x}_{U}}}} & for \underline{{E}_{{x}_{U}}} \leq {E}_{{x}_{U}} \leq \overline{{E}_{{x}_{U}}} \\ 0 & for {E}_{{x}_{U}} \geq \overline{{E}_{{x}_{U}}}\end{matrix} , \\ {μ}_{{E}_{{x}_{D}}} = \{ \begin{matrix}1 & for {E}_{{x}_{D}} \leq \underline{{E}_{{x}_{D}}} \\ \frac{\overline{{E}_{{x}_{D}}} - {E}_{{x}_{D}}}{\overline{{E}_{{x}_{D}}} - \underline{{E}_{{x}_{D}}}} & for \underline{{E}_{{x}_{D}}} \leq {E}_{{x}_{D}} \leq \overline{{E}_{{x}_{D}}} \\ 0 & for {E}_{{x}_{D}} \geq \overline{{E}_{{x}_{D}}}\end{matrix} , \\ {μ}_{{E}_{{x}_{R}}} = \{ \begin{matrix}1 & for {E}_{{x}_{R}} \leq \underline{{E}_{{x}_{R}}} \\ \frac{\overline{{E}_{{x}_{R}}} - {E}_{{x}_{R}}}{\overline{{E}_{{x}_{R}}} - \underline{{E}_{{x}_{R}}}} & for \underline{{E}_{{x}_{R}}} \leq {E}_{{x}_{R}} \leq \overline{{E}_{{x}_{R}}} \\ 0 & for {E}_{{x}_{R}} \geq \overline{{E}_{{x}_{R}}}\end{matrix} ,$$
and further subject to a cost function C=ΣᵢΣₜ(E(FPᵢ))·P(t)·EVₚₑᵣ(t), where P(t) is an energy market price at time t, and further subject to the following constraints:
Σₜ^{T}^{_{trip,i}}E(FPᵢ(t))·Compᵢ(t)·Efᵢ(t)+SOC_{I,i}≦M_{Ci},
ΣₜE(FPᵢ(t))·Compᵢ(t)·Efᵢ(t)+SOC_{I,i}−Tripᵢ≦M_{Ci},
(MxAPᵢ(t)+POPᵢ(t))·Compᵢ(t)·Efᵢ(t)+SOC_{I,i}≦M_{Ci},
RsRPᵢ(t)+POPᵢ(t)−MnAPᵢ(t),
(MxAPᵢ(t)+POPᵢ(t))·Compᵢ(t)≦MPᵢ·Avᵢ(t),
SOCfᵢ≦SOCfdᵢ,
MxAPᵢ(t)≧0,
MnAPᵢ(t)≧0,
RsRPᵢ(t)≧0, and
POPᵢ(t)≧0,
where the expected value of the energy received by the i-th electric vehicle is given by E(FPᵢ(t))=MxAPᵢ(t)Eₓ_{_{D}}+POPᵢ(t)−MnAPᵢ(t)Eₓ_{_{U}}−RsRPᵢ(t)Eₓ_{_{R}}, T_{trip,i} is a time at which the i-th electric vehicle makes a commute trip, Compᵢ(t) is a compensation factor to account for unplanned departures of the i-th electric vehicle, Efᵢ is the efficiency of a battery charger connected to a battery of the i-th electric vehicle, SOC_{I,i} is the initial state of charge of the battery of the i-th electric vehicle, M_{Ci} is the maximum charge of the battery of the i-th electric vehicle, Tripᵢ is a reduction in the state of charge of the battery of the i-th electric vehicle as a result of the commute trip, MxAPᵢ(t) is a maximum additional power draw of the i-th electric vehicle at time t, POPᵢ(t) is a preferred operating point of the i-th electric vehicle at time t, RsRPᵢ(t) is a reduction in power draw of the i-th electric vehicle available for spinning reserves, MnAPᵢ(t) is a minimum additional power draw of the i-th electric vehicle at time t, MPᵢ is a power rating of the battery charger connected to the battery of the i-th electric vehicle, Avᵢ(t) is an availability of the i-th electric vehicle for vehicle-to-grid charging, where Avᵢ(t)=1 if the i-th electric vehicle is available for vehicle-to-grid charging and Avᵢ(t)=0 if the i-th electric vehicle is not available for vehicle-to-grid charging, SOCfᵢ is a final state of charge of the battery of the i-th electric vehicle, and SOCfdᵢ is a desired final state of charge of the battery of the i-th electric vehicle, and
$${Comp}_{i} ( t ) = 1 + \frac{{Dep}_{i} ( t )}{1 - {Dep}_{i} ( t )}$$
$$and$$
$${EV}_{per} ( t ) = \{ \begin{matrix}1 - {\sum }_{time = 1}^{t} {\sum }_{i} {Dep}_{i} ( time ) & if t < {T}_{trip , i} \\ 1 - {\sum }_{time = {T}_{trip}}^{t} {\sum }_{i} {Dep}_{i} ( time ) & if t \geq {T}_{trip , i}\end{matrix} ,$$
where Depᵢ(t) is a probability that the i-th electric vehicle will depart unexpectedly at hour t, and R_{Up}(t)=Σᵢ₌₁^{N}MnAPᵢ(t), R_{Down}(t)=Eᵢ₌₁^{N}MxAPᵢ(t) and R_{RR}(t)=Σᵢ₌₁^{N}RsRPᵢ(t); and
(b) a second set of instructions which, when loaded into main memory and executed by the processor, causes the processor to transmit a charging signal to the i-th battery charger in communication with the battery of the i-th electric vehicle during real-time operation in response to a system operator's regulation or responsive reserve signal.
